(19) United States
(12) Patent Application Publication
(10) Pub. No.: US 2017/0011480 A1
(43) Pub. Date: Jan. 12, 2017

(54) DATA ANALYSIS SYSTEM, DATA ANALYSIS METHOD, AND DATA ANALYSIS PROGRAM

(71) Applicant: UBIC, INC., Tokyo (JP)

(72) Inventors: Masahiro MORIMOTO, Tokyo (JP); Yoshikatsu SHIRAI, Tokyo (JP); Hideki TAKEDA, Tokyo (JP); Kazumi HASUKO, Tokyo (JP); Akiteru HANATANI, Tokyo (JP); Jakob HALSKOV, Tokyo (JP)

(21) Appl. No.: 15/116,211

(22) PCT Filed: Feb. 4, 2014
(86) PCT No.: PCT/JP2014/052579

§ 371 Date: Aug. 2, 2016

(51) Int. Cl. G06Q 50/18; H04L 29/06

(52) U.S. Cl. CPC G06Q 50/18; H04L 63/308; G06Q 50/26

(57) ABSTRACT

In discovery, it is necessary to execute efficiently work and the like. A data analysis system (5) includes an identifying section (121) that, when a first word that indicates a predetermined action is included in data, identifies a second word that indicates an object of the predetermined action; and an association assigner (122) that associates attribute information that indicates an attribute of data including the first word and the second word with the first word and second word.

### TECHNICAL FIELD

The present invention relates to a data analysis system and the like that analyze data recorded in a predetermined computer.

### BACKGROUND ART

When a crime or a legal dispute related to computers (unauthorized accesses, classified information leakage, etc.) occurs, equipment, data or electronic records required for an investigation to find the cause of the crime or the legal dispute are required to be collected and analyzed. Particularly, in civil litigation in the United States, according to the eDiscovery (electronic discovery) system, the plaintiff and the defendant in the litigation are responsible for submitting digital information related to the litigation as evidence.

According to rapid development and proliferation of IT (information technology), much information has been created using computers in business in recent years. Consequently, in a process of preparing for submitting evidentiary materials to a court, errors of including classified information unrelated to the litigation tend to occur. Techniques pertaining to forensic systems that analyze document information are proposed in the following Patent Literatures 1 to 3.

### CITATION LIST

### Patent Literature

PTL 1: Japanese Patent Application Laid-Open No. 2011-209930 (published on Oct. 20, 2011)

PTL 2: Japanese Patent Application Laid-Open No. 2011-209931 (published on Oct. 20, 2011)

PTL 3: Japanese Patent Application Laid-Open No. 2012-032859 (published on Feb. 16, 2012)

### SUMMARY OF INVENTION

### Technical Problem

Unfortunately, the forensic systems disclosed in the Patent Literatures 1 to 3 are required to collect enormous amounts of document information related to users having used computers and servers. Work of classifying whether enormous amounts of digitized document information is appropriate as evidentiary materials for a litigation or not requires a user called a reviewer to visually verify and classify the document information on a piece-by-piece basis, which causes a problem of causing enormous efforts and costs.

The present invention has been made in view of the above problem, and has an object to provide a data analysis system and the like that can efficiently execute, for example, work and the like required for discovery by analyzing a human action.

### Solution to Problem

To solve the above problems, a data analysis system of the present invention is a data analysis system that analyzes data recorded in a predetermined computer, including: an identifying section that, when a first word that indicates a predetermined action is included in the data, identifies a second word that indicates an object of the predetermined action; and an association assigner that associates attribute information that indicates an attribute of data including the first word and the second word with the first word and second word.

In the data analysis system of the present invention, the attribute information may be a name of a person having transmitted the data, a name of a person having received the data, an address that can identify the person, a date and time when the data was transmitted and received, or a date and time when the data was created.

The data analysis system of the present invention may further include an evaluator that evaluates a relationship between the data and a predetermined case, based on the attribute information and the first word and the second word associated by the association assigner.

In the data analysis system of the present invention, the predetermined case may be information indicating a relationship with a litigation or a fraud investigation.

The data analysis system of the present invention may further include a display unit that displays a relationship between people related to the case, based on a result of evaluation by the evaluator.

The data analysis system of the present invention may further include a communication data obtaining unit that obtains, as the data, communication information that has been transmitted and received between terminals and is associated with each of people.

To solve the above problems, a data analysis method of the present invention is a data analysis method that analyzes data recorded in a predetermined computer, including: an identifying step of, when a first word that indicates a predetermined action is included in the data, identifying a second word that indicates an object of the predetermined action; and an association assigning step of associating attribute information that indicates an attribute of data including the first word and the second word with the first word and second word.

To solve the above problems, a data analysis program of the present invention is a data analysis program that analyzes data recorded in a predetermined computer, the program causing the computer to achieve: an identifying function that, when a first word that indicates a predetermined action is included in the data, identifies a second word that indicates an object of the predetermined action; and an association assigning function that associates attribute information that indicates an attribute of data including the first word and the second word with the first word and second word.

### Advantageous Effects of Invention

The data analysis system, the data analysis method and the data analysis program of the present invention can analyze a human action. Consequently, the data analysis system and the like can efficiently execute work required for discovery and the like, for example.

### BRIEF DESCRIPTION OF DRAWINGS

FIG. 1 is a block diagram showing an example of a main configuration of a data analysis system according to a first embodiment of the present invention.

FIG. 2 is a table that lists an example of pairs of first words and second words in a manner viewable at a glance.

FIG. 3 is a flowchart showing a flow of processes executed by an identifying section and an association assigner which are included in an analyzer provided in the data analysis system.

FIG. 4 is a block diagram showing an example of a main configuration of a document classification system according to a second embodiment of the present invention.

FIG. 5 is a chart showing a flow of processes on a stage-by-stage basis according to the second embodiment.

FIG. 6 is a chart showing a processing flow of a keyword database according to the second embodiment.

FIG. 7 is a chart showing a processing flow of a related term database according to the second embodiment.

FIG. 8 is a chart showing a processing flow of a first automatic classifier according to the second embodiment.

FIG. 9 is a chart showing a processing flow of a second automatic classifier according to the second embodiment.

FIG. 10 is a chart showing a processing flow of a classification symbol accepting and assigning unit according to the second embodiment.

FIG. 11 is a chart showing a processing flow of a classification-symbol-accepted document analyzer according to the second embodiment.

FIG. 12 is a graph showing an analysis result in the classification-symbol-accepted document analyzer according to the second embodiment.

FIG. 13 is a chart showing a processing flow of a third automatic classifier according to one example of the second embodiment.

FIG. 14 is a chart showing a processing flow of the third automatic classifier according to another example of the second embodiment.

FIG. 15 is a chart showing a processing flow of a quality inspector according to the second embodiment.

FIG. 16 shows a document display screen according to the second embodiment.

FIG. 17 is a block diagram showing an example of a main configuration of a document classification system according to a third embodiment of the present invention.

FIG. 18 is a chart showing a flow of processes on a stage-by-stage basis according to the third embodiment.

FIG. 19 is a chart showing a processing flow of a database according to the third embodiment.

FIG. 20 is a chart showing a processing flow of a word searcher according to the third embodiment.

FIG. 21 is a chart showing a processing flow of a score calculator according to the third embodiment.

FIG. 22 is a chart showing a processing flow of an automatic classifier according to the third embodiment.

FIG. 23 is a chart showing a processing flow of a document excluder according to the third embodiment.

FIG. 24 is a block diagram showing an example of a main configuration of a correlation display system according to a fourth embodiment of the present invention.

FIG. 25 is a diagram showing a display mode of a display unit included in the correlation display system.

FIG. 26 is a flowchart showing a flow of processes executed by the correlation display system.

FIG. 27 is a hardware configuration diagram of the correlation display system.

### DESCRIPTION OF EMBODIMENTS

### Embodiment 1

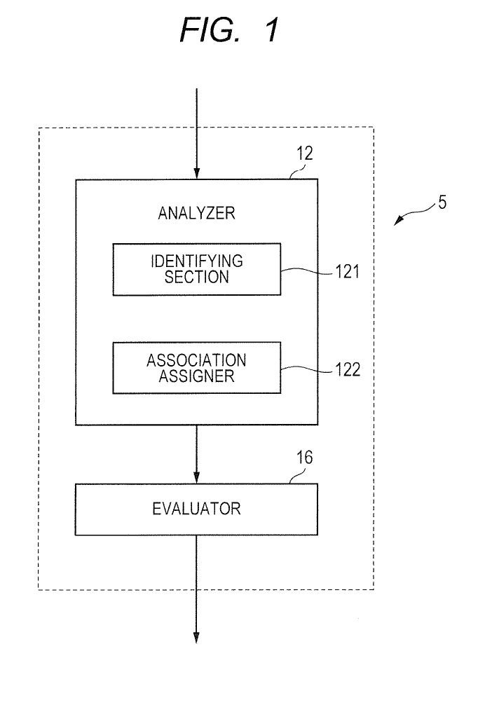

Referring to FIGS. 1 to 3, a first embodiment (Embodiment 1) according to the present invention is described.

(Overview of Data Analysis System 5)

A data analysis system 5 is a system that analyzes data recorded in a predetermined computer. First, the data analysis system 5 analyzes the content of data obtained from the outside (predetermined computer). In this analysis, when a first word that indicates a predetermined action is included in the data, the data analysis system 5 identifies a second word that indicates an object of the predetermined action. For example, when text “finalize the specifications” is included in the data, words “specifications” and “finalize” are extracted from the text, the second word “specifications” (object) that is an object of the first word (verb) indicating a predetermined act “finalize” is identified.

Next, the data analysis system 5 associates meta-information (attribute information) that indicates an attribute (properties and characteristics) of the data including the first word and second word with the first word and second word. Here, the meta-information is information that indicates a predetermined attribute of the data. For example, in the case where the data is email, the meta-information may be the name of a person having transmitted the email, the name of a person having received the email, the email address, and the date and time of transmission and reception. In the case where the data is presentation materials, the meta-data may be the date and time of creation of the presentation materials.

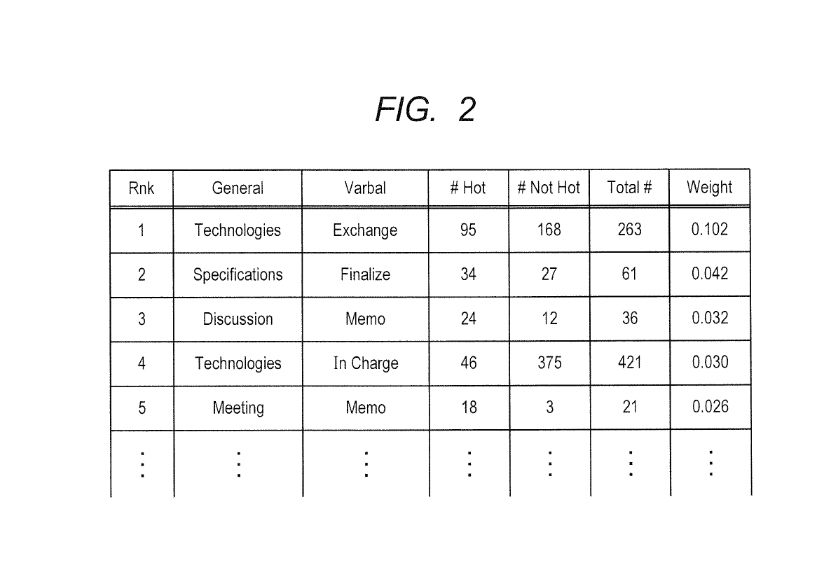

FIG. 2 is a table that lists an example of pairs of first words and second words in a manner viewable at a glance. In FIG. 2, words listed on the second column of this table are objects of words (Japanese irregular s-stem verbs) listed on the third column. For example, when text “exchange technologies” is included in email (data, communication information) and words “technologies” (second word) and “exchange” (first word) are extracted (see the first row of the table shown in FIG. 2), the data analysis system 5 associates the “technologies” and “exchange” with the names of people (e.g., “person A” and “person B”) having transmitted and received the email. It can thus be estimated that “person A” and “person B” intend to “exchange” certain “technologies”.

Furthermore, for example, the text “finalize the specifications” is included in the presentation materials attached to the email and “specifications” (second word) and “finalize” (first word) are extracted (see the second row of the table shown in FIG. 2), the correlation display system 1 associates the “specifications” and “finalize” with the date and time of creation of the presentation materials (e.g., Jan. 16, 2014, 16:30). Consequently, it can be estimated that while “person A” and “person B” intend to “exchange” certain “technologies”, they try to “finalize” the “specifications” of the “technologies” at the time of Jan. 16, 2014, 16:30.

That is, the data analysis system 5 can extract the parts (first word and second word) related to the human action from the predetermined data, and associates the extracted parts with the meta-information, thereby allowing the human action to be analyzed.

Consequently, when work such as discovery is executed for example, the data analysis system 5 can extract the action related to a predetermined case (litigation or fraud investigation) from the data and identify the association with the data, thereby allowing the discovery to be efficiently executed. Furthermore, the data analysis system 5 can grasp the relationship between people having high relevance to a predetermined case. Consequently, oversight of important data in work, such as discovery, can be prevented.

(Configuration of Data Analysis System 5)

FIG. 1 is a block diagram showing an example of a main configuration of the data analysis system 5 according to Embodiment 1. A data analysis system 5 is a system that analyzes data recorded in a predetermined computer. As shown in FIG. 1, the data analysis system 5 includes an analyzer 12 (an identifying section 121 and an association assigner 122). The data analysis system 5 may further include an evaluator 16.

The analyzer 12 analyzes the content of data obtained from the predetermined computer. More specifically, the analyzer 12 analyzes text data included in the content of the data using a text mining method (in the case where the data is text information), an image recognition method (in the case where the data is an image) or a speech recognition method (in the case where the data is audio information). The analyzer 12 then analyzes whether or not the content of the data includes text, an image or a sound that are related to the predetermined case.

Here, the predetermined case is information that indicates a relationship with a litigation. The information may be not only the relationship with a litigation, but also correlation of human relations in fraud investigation, or what is related to correlation between people, accounting and technical information in M&A or intellectual property.

For example, the analyzer 12 includes a dictionary section that stores text data indicating words related to the predetermined case. The analyzer 12 analyzes the text data included in the content of the data using the text data stored in the dictionary section, thus analyzing whether the text related to the case is included in the content of the data or not.

When an analysis result indicating that the text is included is obtained, the analyzer 12 can assign information related to the part of speech of the text to the text. Here, the parts of speech are information classified on the basis of the grammatical functions and morphology, and are, for example, noun, verb, adjective and the like. The analyzer 12 includes the identifying section 121 and the association assigner 122. The analyzer 12 outputs the analyzed result to the identifying section 121.

When a first word that indicates a predetermined action is included in the text (data), the identifying section 121 identifies a second word that indicates an object of the predetermined action. More specifically, the identifying section 121 determines whether the word included in the text is a verb (a word indicating a predetermined act) or not. When the word is a verb, the identifying section 121 identifies the second word (object) that is the object of the predetermined action represented by the word concerned (first word). For example, when words “specifications” and “finalize” are extracted from the text “finalize the specifications”, the identifying section 22 identifies the second word “specifications” (object) that is an object of the first word (verb) indicating a predetermined act “finalize”. The identifying section 121 outputs the first word and the second word to the association assigner 122.

The association assigner 122 associates meta-information (attribute information) that indicates the attribute of the data including the first word and second word with the first word and second word. For example, when words “technologies” (second word) and “exchange” (first word) are input through the identifying section 121, the association assigner 122 associates the “technologies” and “exchange” with the names of people (e.g., “person A” and “person B”) having transmitted and received the data including the text. The association assigner 122 outputs the result of association to the evaluator 16.

The evaluator 16 evaluates the relationship between the content of data and the predetermined case using the analysis result of the analyzer 12 (association assigner 122). For example, the evaluator 16 evaluates the relationship between the content of data and the predetermined case by executing an automatic code assigning process. Next, the evaluator 16 assigns the data a code that is information having been obtained from the outside and associating relationship with the predetermined case. The relationship with the predetermined case is information indicating that the data has the relationship with the predetermined case, information indicating the degree of relationship between the data and the predetermined case and the like.

The evaluator 16 then executes the automatic code assigning process to the entire data analyzed by the analyzer 12, or the entire data analyzed by the analyzer 12 that the text data related to the predetermined case is included, using the data assigned the information associating the relationship with the predetermined case. Consequently, the evaluator 16 evaluates whether the data transmitted from one person to another person is related to the predetermined case or not, and the degree of relevance of the data with the predetermined case.

For example, the evaluator 16 evaluates whether email transmitted from an information processing apparatus of a first person to an information processing apparatus of a second person is related to the predetermined case or not. When the email is related to the case, the evaluator 16 associates a score with the email. Likewise, the evaluator 16 associates scores with all pieces of the email transmitted from the information processing apparatus of the first person to the information processing apparatus of the second person, and adds up the associated scores, thus calculating the score of relationship between the first person and the second person. Likewise, the evaluator 16 evaluates every piece of email transmitted from an information processing apparatus of one person to each of information processing apparatuses of other people. The evaluator 16 calculates scores for the respective relationships between the one person and the other people, and performs evaluation.

The evaluator 16 also evaluates whether email transmitted from an information processing apparatus in a first domain to an information processing apparatus in a second domain is related to the predetermined case or not. When the email is related to the case, the evaluator 16 associates a score with the email. Likewise, the evaluator 16 associates scores with all pieces of the email transmitted from the information processing apparatus in the first domain to the information processing apparatus in the second domain, and adds up the associated scores, thus calculating the score of relationship between the first domain and the second domain. Likewise, the evaluator 16 evaluates every piece of email transmitted from an information processing apparatus in one domain to each of information processing apparatuses of other domains. The evaluator 16 calculates scores for the respective relationships between the one domain and the other domains, and performs evaluation.

When the evaluator 16 evaluates the relationship on the basis of the data analysis result, the evaluation is executed as follows, for example. First, the evaluator 16 may include a dictionary that associates the combinations of words related to the predetermined case with scores indicating the degrees of relevance with the predetermined case, and stores the associated combinations. The evaluator 16 then analyzes text data in the data on the basis of morphological analysis, and determines whether the combination of words stored in the dictionary is included in the selected data or not.

When the evaluator 16 determines that the combination of words stored in the dictionary is included in the selected data, this evaluator evaluates the degree of relevance of the file to the predetermined case on the basis of the score stored in the dictionary. The evaluator 16 then associates the information representing the evaluation result (i.e., the information indicating the degree of relevance to the predetermined case) with the selected data. The evaluator 16 can thus evaluate the degree of relationship between the data and the predetermined case.

Furthermore, the evaluator 16 can evaluate the degree of relevance of the data to the predetermined case on every data transmission and reception times through reading the transmission and reception times included in the data. The evaluator 16 can also evaluate the degree of relevance of the data to the predetermined case on every execution time the evaluation is performed.

(Processes Executed by Data Analysis System 5)

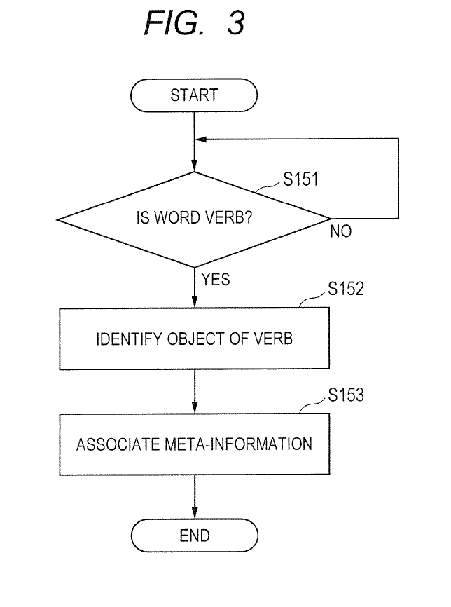

FIG. 3 is a flowchart showing a flow of processes executed by the identifying section 121 and the association assigner 122 which are included in the analyzer 12 provided in the data analysis system 5.

The identifying section 121 determines whether the word included in the data (text) analyzed by the analyzer 12 is a verb (a word indicating a predetermined act) or not (S151). When the word is a verb (YES in S151), the identifying section 22 identifies the second word that is the target of the predetermined action represented by the word concerned (first word) (S152, identification step). The association assigner 24 associates meta-information that indicates the attribute of the data including the first word and second word with the first word and second word (S153, association assigning step).

After the above S153, the evaluator 16 may evaluate the relationship between the content of data and the predetermined case using the analysis result by the analyzer 12.

### Embodiment 2

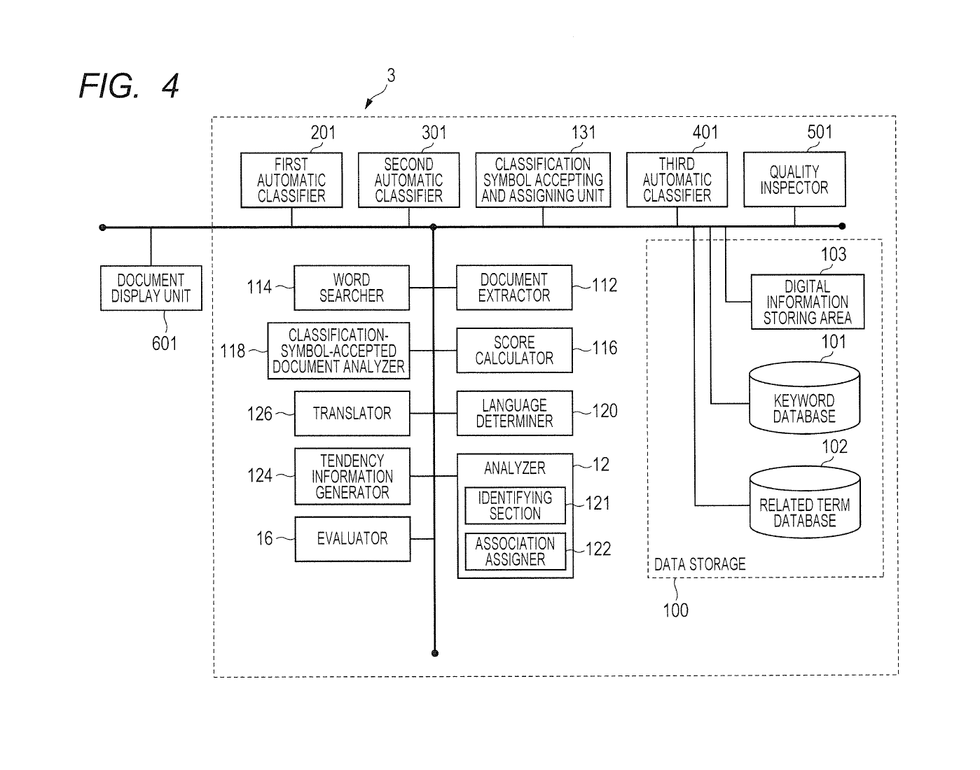

Referring to FIGS. 4 to 16, a second embodiment (Embodiment 2) according to the present invention is described. The following description is only for the functions and configuration that can be changed from those of Embodiment 1. The detailed description on the other functions and configuration is omitted because of similarity thereof to those in Embodiment 1.

(Configuration of Document Classification System 3)

FIG. 4 is a block diagram showing an example of a main configuration of a document classification system 3 according to Embodiment 2. The document classification system (data analysis system) 3 is a system that obtains digital information recorded in computers or servers, analyzes document information made up of multiple documents included in the obtained digital information, and assigns a classification symbol that indicates the degree of relevancy to a litigation, thereby facilitating use for the litigation.

As shown in FIG. 4, the document classification system 3 includes the analyzer 12 (the identifying section 121 and the association assigner 122) and the evaluator 16 which have been described in Embodiment 1. Consequently, the document classification system 3 exerts advantageous effects analogous to those of the aforementioned data analysis system 5.

That is, when work such as discovery is executed for example, the document classification system 3 can extract the action related to a predetermined case (litigation or fraud investigation) and identify the association with the data, thereby allowing a classification symbol representing the degree of relevancy to the case concerned to be accurately assigned. Consequently, the document classification system 3 can efficiently execute the discovery.

The analyzer 12 analyzes the content of documents extracted by a document extractor 112, thereby analyzing whether text having a relationship with the predetermined case is included in the documents or not.

When a first word that indicates a predetermined action is included in the text (data), the identifying section 121 identifies a second word that indicates an object of the predetermined action.

The association assigner 122 associates meta-information (attribute information) that indicates the attribute of the data including the first word and second word with the first word and second word.

The evaluator 16 evaluates the relationship between the content of the document and the predetermined case using the analysis result of the analyzer 12 (association assigner 122).

The document classification system 3 includes a data storage 100 that obtains digital information recorded in computers or servers to use the information for a litigation and stores the obtained digital information in a digital information storing area 103. The data storage 100 stores keyword database 101 where a specific classification symbol of a document included in the obtained digital information, a keyword having close relationship with the specific classification symbol, and keyword correspondence information that indicates the correspondence relationship between the specific classification symbol and the keyword are registered, and a related term database 102 where a predetermined classification symbol, a related term including a word having a high appearance frequency in the document assigned the predetermined classification symbol, and related term correspondence information that indicates the correspondence relationship between the predetermined classification symbol and the related term are registered. As shown in FIG. 4, the data storage 100 may be provided in the document classification system, or provided outside of the document classification system 3 as a separate storage device.

The document classification system 3 includes the document extractor 112 that extracts multiple documents from document information, a word searcher 114 that searches the document information for a keyword or a related term which is recorded in the database, and a score calculator 116 that calculates the strength of connection between the document and the classification symbol. The score calculator 116 can calculate the score on the basis of the relationship evaluated by the evaluator 16. Consequently, the document classification system 3 can accurately add the classification symbol indicating the degree of relevancy with the case.

The document classification system 3 includes: a first automatic classifier 201 that causes the word searcher 114 to search for the keyword recorded in the keyword database 101, extracts a document including the keyword from the document information, and automatically assigns a specific classification symbol to the extracted document on the basis of the keyword correspondence information; and a second automatic classifier 301 that extracts, from the document information, the document including the related term recorded in the related term database, calculates the score on the basis of the evaluated values and the number of related terms included in the extracted document, and automatically assigns a predetermined classification symbol to the document having the score exceeding a certain value on the basis of the score and the related term correspondence information.

The document classification system 3 further includes: a document display unit 601 that displays multiple documents extracted from the document information on the screen; a classification symbol accepting and assigning unit 131 that accepts the classification symbol assigned by a user to the documents to which the classification symbol extracted from the document information is not assigned, on the basis of the relevance to the litigation, and assigns the classification symbol; a classification-symbol-accepted document analyzer 118 that analyzes the document assigned the classification symbol by the classification symbol accepting and assigning unit 131; and a third automatic classifier 401 that automatically assigns the classification symbol to the multiple documents extracted from the document information, on the basis of the analysis result obtained by the classification-symbol-accepted document analyzer 118 analyzing the document having been assigned the classification symbol by the classification symbol accepting and assigning unit 131.

The document classification system 3 may further include a language determiner 120 that determines the type of language of the extracted document, and a translator 126 that translates the extracted document upon acceptance of designation by the user or automatically. The delimited unit of the language in the language determiner 120 is set smaller than one sentence so as to support multiple languages in one sentence. Any or both of predictive coding and character coding may be used to determine the language. Furthermore, a process of excluding the header of HTML and the like from the target of translation may be performed.

The document classification system 3 may further include a tendency information generator 124 that generates tendency information that represents the degree of similarity to the document assigned the classification symbol of each document on the basis of the types of words, the number of appearances, and the evaluated values of the words included in each document, so as to perform analysis by the classification-symbol-accepted document analyzer 118.

The document classification system 3 may further include a quality inspector 501 that compares the classification symbol accepted by the document symbol accepting and assigning unit 131 with the classification symbol assigned according to the tendency information in the classification-symbol-accepted document analyzer 118, and verifies the appropriateness of the classification symbol accepted by the document symbol accepting and assigning unit 131.

### DESCRIPTION OF TERMS

To facilitate understanding of the document classification system according to each embodiment, terms specific to each embodiment are described as follows.

The term “classification symbol” is an identifier used to classify documents, and represents the degree of relevancy to a litigation to facilitate use for the litigation. For example, the symbol may be assigned according to the type of an evidence when document information is used as an evidence in a litigation.

The term “document” is data that includes at least one word. Examples of “documents” include email, presentation materials, spreadsheet materials, discussion materials, a written contract, an organization chart, and a business plan.

The term “word” a unit of the minimum character string having meaning. For example, the text “the document is data that includes at least one word” includes words “document”, “one”, “at least”, “word”, “includes”, “data”, and “is”.

The term “keyword” is one “word” or “words” or a combination of “morphemes”. More specifically, the keyword has a close relationship with a specific classification symbol, and the keyword may be what uniquely determines the classification symbol when the keyword is included in a document. For example, in case a patent infringement litigation occurs, “keywords” for the case where the classification symbol of important is assigned to a document having a high degree of relevancy to the litigation include “patent gazette number”, “patent attorney” and “infringer”.

The term “keyword correspondence information” represents the correspondence relationship between a keyword and a specific classification symbol. For example, if the classification symbol “important” representing an important document in a litigation has a close relationship with a keyword “infringer”, the “keyword correspondence information” may be information that manages the classification symbol “important” and the keyword “infringer” in association with each other.

The term “related term” is a word having an evaluated value of at least a certain value among words having a high appearance frequency common to the documents assigned a predetermined classification symbol. For example, the appearance frequency is a ratio of appearance of the related term to the total number of words appearing in one document.

The term “evaluated value” is the amount of information exerted by each word in a certain document. The “evaluated value” may be calculated with reference to the amount of transmitted information, or calculated with reference to the relevance evaluated by the evaluator 16. For example, when a predetermined trade name is assigned as a classification symbol, the “related term” may indicate the name of a technical field to which the product belongs, a country where the product is sold, a trade name similar to that of the product. More specifically, the “related terms” in the case of assigning, as a classification symbol, the trade name of an apparatus to which an image coding process is applied may include “coding process”, “Japan” and “encoder”.

The term “related term correspondence information” represents the correspondence relationship between a related term and a classification symbol. For example, when a classification symbol “product A” which is a trade name related to a litigation has a related term “image coding” which is a function of the product A, the “related term correspondence information” may be information where the classification symbol “product A” and the related term “image coding” are associated with each other and managed.

The term “score” is qualitative evaluation of the strength of connection with a specific classification symbol in a certain document. In each embodiment of the present invention, for example, the score is calculated on the basis of words appearing in a document and the evaluated value of each word using the following expression (1).

[Expression 1]

Scr=Σᵢ₌₀^{N}i*(mᵢ*wgtᵢ²)/Σₜ₌₀^{N}i*wgtᵢ² (1)

Scr: Score of document
mᵢ: Appearance frequency of i-th keyword or related term
wgtᵢ²: Weight of i-th keyword or related term

The document classification system 3 may extract a word that frequently appears in documents having a common classification symbol assigned by the user. The tendency information which is included in each document and is on the type of the extracted word, the evaluated value of each word, and the number of appearances may be analyzed on a document-by-document basis, and a common classification symbol may be assigned to a document having the same tendency as the analyzed tendency information among documents where no classification symbol is accepted by the classification symbol accepting and assigning unit.

Here, the term “tendency information” represents the degree of similarity to the document assigned the classification symbol of each document, and is represented by the degree of relevancy to the predetermined classification symbol based on the type of the word included in each document, the number of appearances, and the evaluated value of the word. For example, when each document is similar to the document assigned the predetermined classification symbol in degree of relevancy with this predetermined classification symbol, the two documents have the same tendency information. Documents including words having the same evaluated value with the same number of appearance even if the types of included words are different from each other may be regarded as documents having the same tendency.

The document classification system 3 may include a quality inspector that determines the classification symbol to be assigned to the document to which the user has assigned the classification symbol, on the basis of the analyzed tendency information, compares the determined classification symbol with the classification symbol assigned by the user, and verifies the appropriateness.

(Processes Executed by Document Classification System 3)

In Embodiment 2, according to a flowchart as shown in FIG. 5, a registration process, a classification process and an inspection process are performed in first to fifth stages.

On the first stage, the keyword and the related term are preliminarily registered using a result of a previous classification process (STEP 100). At this time, the keyword and the related term are registered together with the keyword correspondence information and the related term correspondence information which are correspondence information on the classification symbol and the keyword or the related term.

On the second stage, a first classification process is executed that extracts a document including the keyword registered in the first stage from the entire document information, refers to the keyword correspondence information recorded in the first stage upon finding the document, and assigns the classification symbol corresponding to the keyword (STEP 200).

On the third stage, the document including the related term registered in the first stage is extracted from the document information assigned no classification symbol in the second stage, and the score of the document including the related term is calculated. A second classification process is executed that refers to the calculated score and the related term correspondence information recorded on the first stage and assigns the classification symbol (STEP 300).

On the fourth stage, the classification symbol assigned by the user is accepted with respect to the document information where no classification symbol has been assigned until the third stage, and the classification symbol accepted from the user is assigned to the document information. Next, a third classification process is executed that analyzes the document information assigned the classification symbol accepted from the user, extracts the document assigned no classification symbol on the basis of the analysis result, and assigns the classification symbol to the extracted document. For example, a word frequently appearing in documents with the common classification symbol assigned by the user is extracted, the tendency information which is included in each document and is on the type of the extracted word, the evaluated value of each word, and the number of appearances may be analyzed on a document-by-document basis, and a common classification symbol is assigned to a document having the same tendency as the tendency information (STEP 400).

On the fifth stage, the classification symbol to be assigned to the document to which the user has assigned the classification symbol is determined on the basis of the analyzed tendency information, the determined classification symbol is compared with the classification symbol assigned by the user, and the appropriateness of the classification process is verified. (STEP 500)

Here, the tendency information used in the processes in the fourth and fifth stages is of each document, represents the degree of similarity to the document assigned the classification symbol, and is based on the type of the word included in each document, the number of appearances, and the evaluated value of the word. For example, when each document is similar to the document assigned the predetermined classification symbol in degree of relevancy with this predetermined classification symbol, the two documents have the same tendency information. Documents including words having the same evaluated value with the same number of appearance even if the types of included words are different from each other may be regarded as documents having the same tendency.

Detailed processing flows in each of the first to fifth stages are described as follows.

<First Stage (STEP 100)>

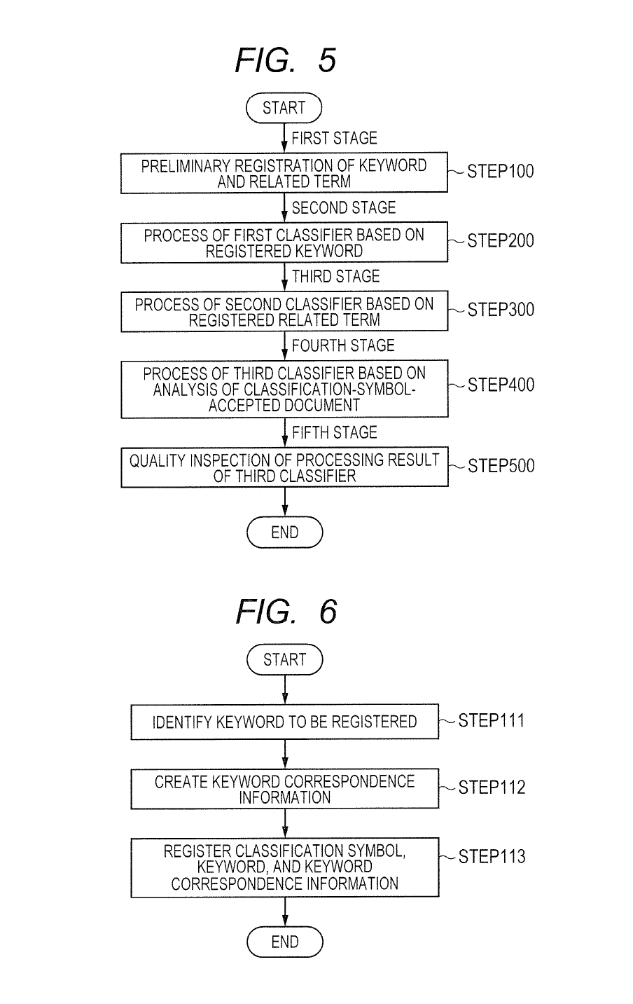

A detailed processing flow of the keyword database 101 on the first stage is described with reference to FIG. 6.

The keyword database 101 creates a table for management for each classification symbol in consideration of a result of classification of documents in previous litigations, and identifies a keyword corresponding to each classification symbol (STEP 111). In Embodiment 2, the identification may be made by analyzing the document assigned each classification symbol, using the number of appearances and evaluated value of each keyword in the document. Alternatively, a method of using the amount of transmitted information held by the keyword, or a method of manual selection by the user may be adopted.

In Embodiment 2, for example, when keywords “infringement” and “patent attorney” are identified as keywords of a classification symbol “important”, keyword correspondence information indicating that the “infringement” and “patent attorney” are keywords having close relationship with the classification symbol “important” is created (STEP 112). The identified keyword is registered in the keyword database. In this case, the identified keyword and the keyword correspondence information are associated with each other, and recorded in the management table of the classification symbol “important” of the keyword database (STEP 113).

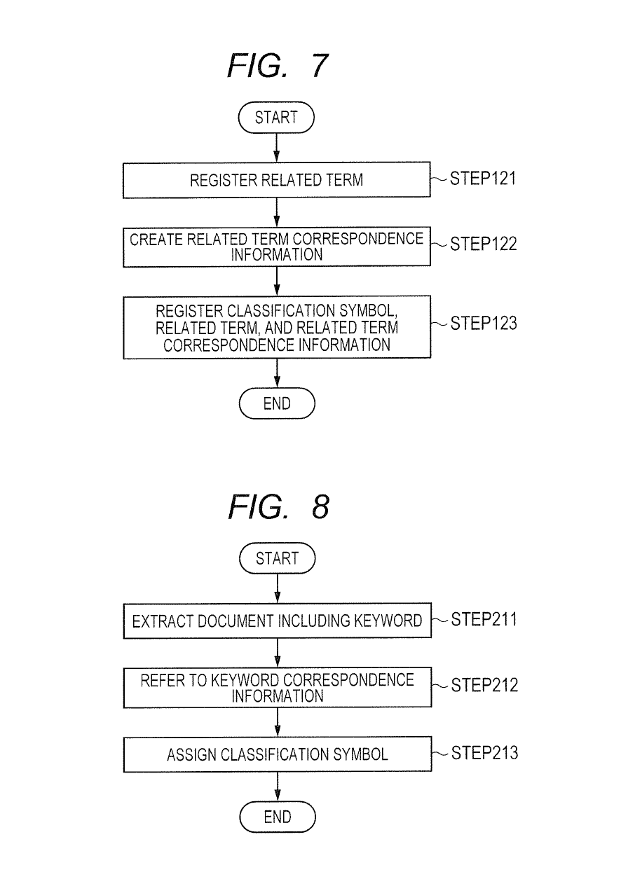

Next, a detailed processing flow of the related term database 102 is described with reference to FIG. 7. The related term database 102 creates a table for management for each classification symbol in consideration of a result of classification of documents in previous litigations, and registers a related term corresponding to each classification symbol (STEP 121). In Embodiment 2, for example, “coding process” and “product a” are registered as related terms of “product A”, and “decode” and “product b” are registered as related terms of “product B”.

The related term correspondence information indicating correspondence of the registered related terms to the classification symbols is created (STEP 122), and recorded in each management table (STEP 123). At this time, in the related term correspondence information, the evaluated value of each related term, and a threshold that serves as a score required to determine the classification symbol are recorded together.

<Second Stage (STEP 200)>

A detailed processing flow of the first classifier 201 on the second stage is described with reference to FIG. 8. In Embodiment 2, in the second stage, a process of assigning the classification symbol “important” to the document is performed by the first classifier 201.

The first classifier 201 extracts, from the document information, a document that includes “infringement” and “patent attorney” registered in the keyword database 101 in the first stage (STEP 100), and extracts, from the document information, the document that includes keywords “infringement” and “patent attorney” registered in the keyword database 101 (STEP 211). With respect to the extracted document, according to the keyword correspondence information, the management table that records the keyword is referred to (STEP 212), and the classification symbol “important” is assigned (STEP 213).

<Third Stage (STEP 300)>

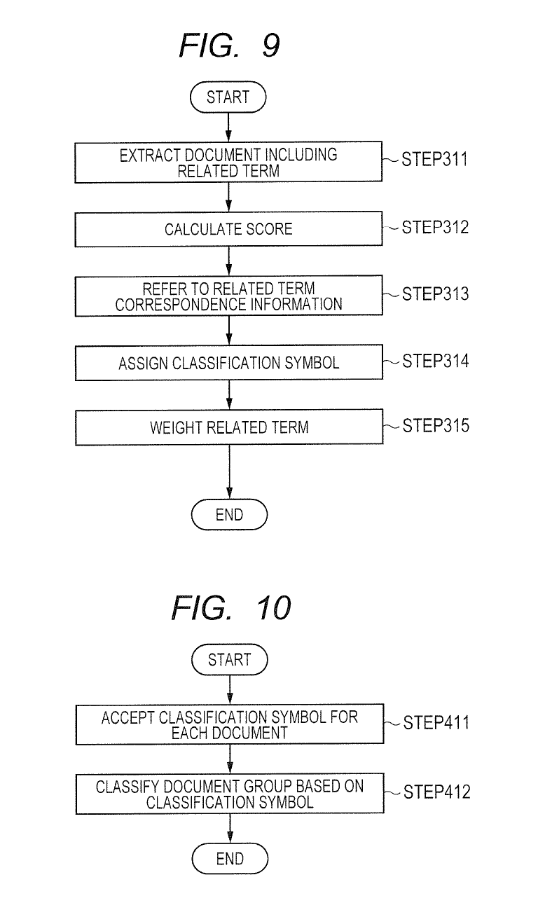

A detailed processing flow of the second classifier 301 on the third stage is described with reference to FIG. 9. In Embodiment 2, the second classifier 301 performs a process of assigning the classification symbols “product A” and “product B” to the document information having been assigned no classification symbol on the second stage (STEP 200).

The second classifier 301 extracts documents including the related terms “coding process”, “product a”, “decode” and “product b”, which have been recorded in the related term database 102 on the first stage, from the document information (STEP 311). The scores of the extracted documents are calculated by the score calculator 116 using the expression (1) on the basis of the appearance frequencies and evaluated values of the recorded four related terms (STEP 312). The score represents the degree of relevancies between each document and the classification symbols “product A” and “product B”.

When the score exceeds the threshold, the related term correspondence information is referred to (STEP 313), and an appropriate classification symbol is assigned (STEP 314).

For example, when the appearance frequencies of the related terms “coding process” and “product a” and the evaluated value of the related term “coding process” are high and the score representing the degree of relevancy to the classification symbol “product A” exceeds the threshold in a certain document, the document is assigned the classification symbol “product A”.

At this time, when the appearance frequency of the related term “product b” is also high and the score representing the degree of relevancy to the classification symbol “product B” exceeds the threshold, the document is assigned the classification symbol “product B” besides the classification symbol “product A”. On the contrary, when the appearance frequency of the related term “product b” is low and the score representing the degree of relevancy to the classification symbol “product B” does not exceed the threshold, the document is only assigned the classification symbol “product A”.

In the second classifier 301, the evaluated value of the related term is recalculated according to the following expression (2) using the score calculated in STEP 432 on the fourth stage, and the evaluated value is weighted (STEP 315).

[Expression 2]

wgt_{i,L}=\sqrt{wgt_{L-t}²+γ_{L}wgt_{i,L}²−θ}=\sqrt{wgt_{i,L}²+Σₗ₌₁^{L}(γₗwgt_{i,l}²−θ)} (2)

wgt_{i,0}: Weight of i-th selected keyword before learning (initial value)
wgt_{i,L}: Weight of i-th selected keyword after L times of learning
Y_{L}: Learning parameter in L-th learning
θ: Threshold of learning effect

For example, when a certain number of documents that have a significantly high appearance frequency of “decode” but have a score is as low as a certain value or less occur, the evaluated value of the related term “decode” is reduced and recorded in the related term correspondence information again.

<Fourth Stage (STEP 400)>

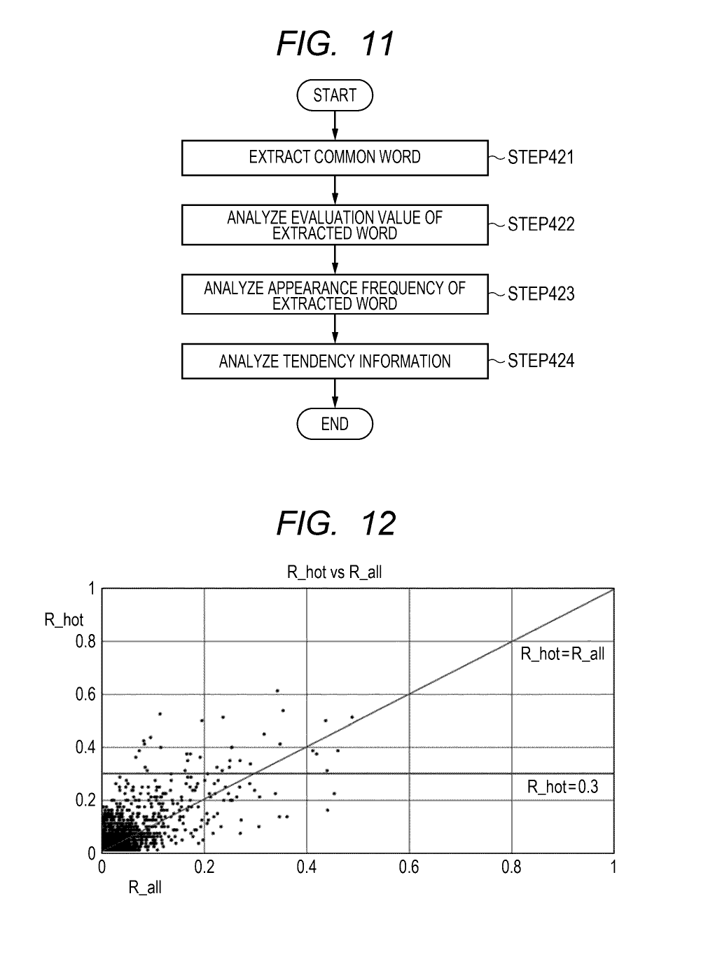

On the fourth stage, as shown in FIG. 10, assignment of the classification symbol from a reviewer to a certain ratio of pieces of document information extracted from the document information having being assigned no classification symbol until the processes of the third stage is accepted, and the accepted classification symbol is assigned to the document information. Next, as shown in FIG. 11, the document information assigned the classification symbol accepted from the reviewer is analyzed, the document information assigned no classification symbol is assigned the classification symbol on the basis of the analysis result. In Embodiment 2, on the fourth stage, for example, a process of assigning the classification symbols “important”, “product A” and “product B” is executed. The fourth stage is further described as follows.

A detailed flow of the classification symbol accepting and assigning unit 131 on the fourth stage is described with reference to FIG. 10. First, the document extractor 112 randomly samples document from the document information that is to be a processing target on the fourth stage, and displays the document on the document display unit 601. In Embodiment 2, documents that are 20% of document information to be processed are randomly extracted, and treated as classification targets to be classified by the reviewer. The sampling may be performed according to an extraction method that arranges the documents in an order of the creation date and time or name and selects 30% of documents from the top.

The user views a document display screen I1 that is displayed on the document display unit 601 and shown in FIG. 16, and selects the classification symbol to be assigned to each document. The classification symbol accepting and assigning unit 131 accepts the classification symbol selected by the user (STEP 411), and performs classification on the basis of the assigned classification symbol (STEP 412).

Next, a detailed flow of the classification-symbol-accepted document analyzer 118 is described with reference to FIG. 11. The classification-symbol-accepted document analyzer 118 extracts a word frequently appearing in common to the documents classified by the classification symbol accepting and assigning unit 131, according to each classification symbol (STEP 421). The evaluated value of the common word extracted is analyzed according to the expression (2) (STEP 422), and the appearance frequency of the common word in the document is analyzed (STEP 423).

Furthermore, in consideration of the results analyzed in STEP 422 and STEP 423, the tendency information on the document assigned the classification symbol “important” is analyzed (STEP 424).

FIG. 12 is a graph of results of analysis of words frequently appearing in common to the documents assigned the classification symbol “important” in STEP 424.

In FIG. 12, the ordinate axis R_hot represents the ratio of documents that includes the word selected as a word associated with the classification symbol “important” and is assigned the classification symbol “important” among all the documents assigned the classification symbol “important”. The abscissa axis represents the ratio of documents that includes the word extracted in STEP 421 by the classification symbol accepting and assigning unit 131 among all the documents to which the user has applied the classification process.

In Embodiment 2, the classification symbol accepting and assigning unit 131 extracts words plotted higher than a straight line R_hot=R_all as the common words with the classification symbol “important”.

The processes in STEP 421 to STEP 424 are executed also to documents assigned the classification symbols “product A” and “product B”, and the tendency information on the documents is analyzed.

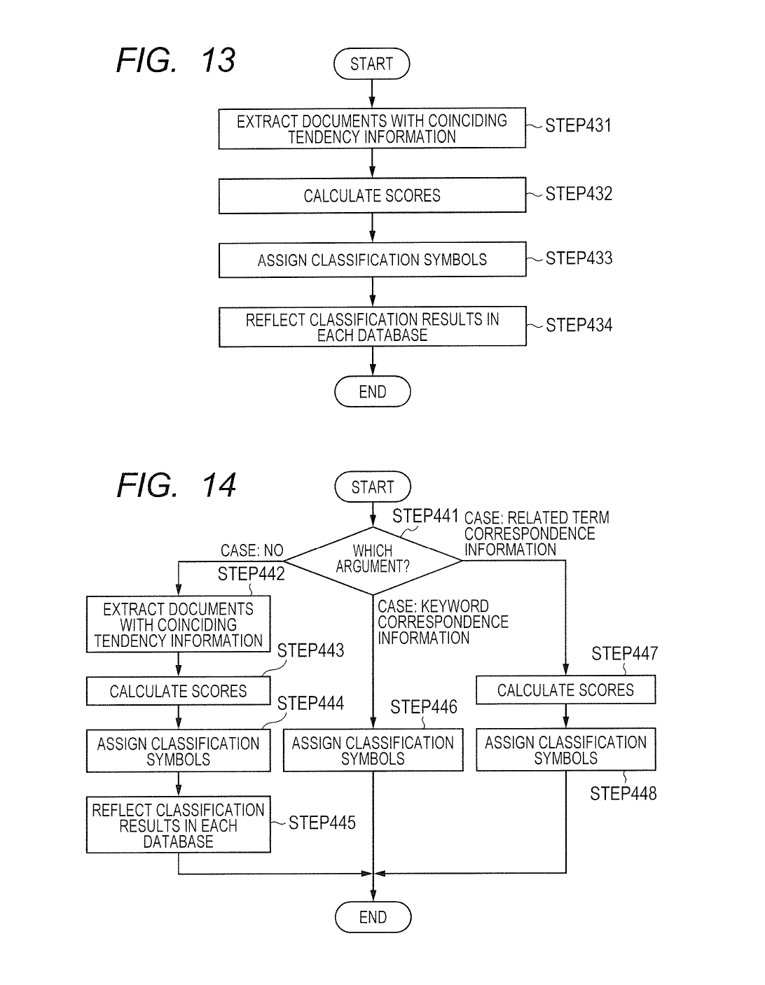

Next, a detailed processing flow of the third automatic classifier 401 is described with reference to FIG. 13. The third automatic classifier 401 applies a process to documents where assignment of the classification symbol has not been accepted by the classification symbol accepting and assigning unit 181 in STEP 411 among the processing target document information on the fourth stage. The third automatic classifier 401 extracts documents having the same tendency information as the documents that have been analyzed in STEP 424 and assigned the classification symbols “important”, “product A” and “product B” (STEP 431), and calculates the scores of the extracted documents on the basis of the tendency information using the expression (1) (STEP 432). The documents extracted in STEP 431 are assigned appropriate classification symbols on the basis of the tendency information (STEP 433).

The third automatic classifier 401 reflects the classification result in each database using the scores calculated in STEP 432 (STEP 434). More specifically, a process may be performed that reduces the evaluated values of the keyword and the related term included in the document with a low score while increasing the evaluated values of the keyword and the related term included in the document with a high score.

Furthermore, an example of a detailed processing flow of the third automatic classifier 401 is described with reference to FIG. 14. The third automatic classifier 401 may apply a classification process to documents where assignment of the classification symbol has not been accepted by the classification symbol accepting and assigning unit 131 in STEP 411 among the processing target document information on the fourth stage. When no argument is provided (STEP 441: NO), the third automatic classifier 401 extracts documents having the same tendency information as the documents that have been analyzed in STEP 424 and assigned the classification symbol “important” (STEP 442), and calculates the scores of the extracted documents on the basis of the tendency information using the expression (1) (STEP 443). The documents extracted in STEP 442 are assigned appropriate classification symbols on the basis of the tendency information (STEP 444).

The third automatic classifier 401 reflects the classification result in each database using the scores calculated in STEP 443 (STEP 445). More specifically, a process is performed that reduces the evaluated values of the keyword and the related term included in the document with a low score while increasing the evaluated values of the keyword and the related term included in the document with a high score.

<Fifth Stage (STEP 500)>

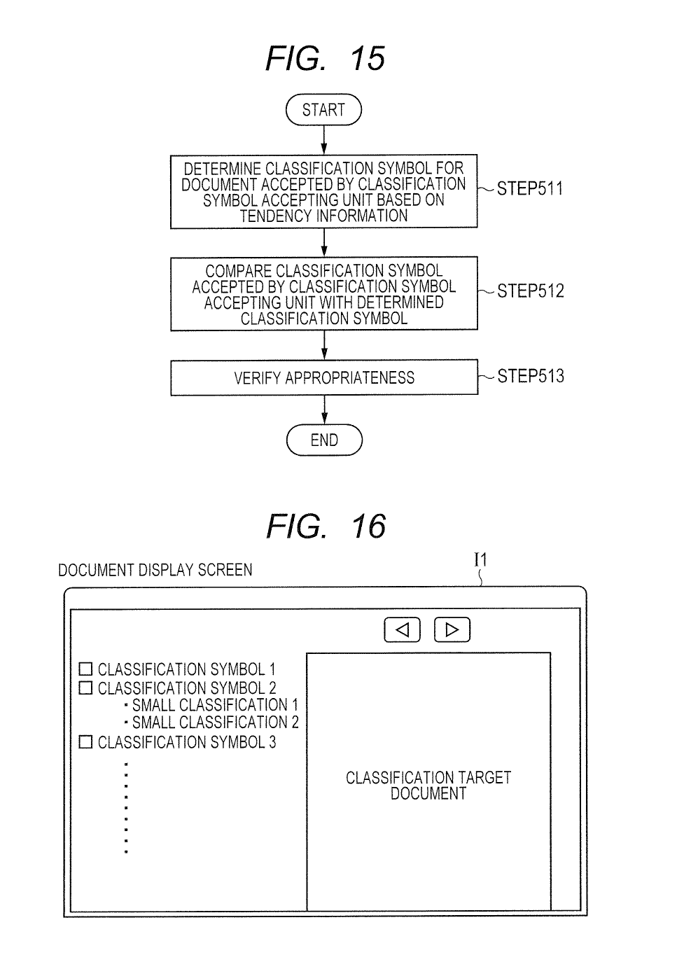

A detailed processing flow of the quality inspector 501 on the fifth stage is described with reference to FIG. 15. In the quality inspector 501, the classification symbol accepting and assigning unit 131 determines a classification symbol to be assigned to the document accepted in STEP 411, on the basis of the tendency information analyzed by the classification-symbol-accepted document analyzer 118 in STEP 424 (STEP 511).

The classification symbol accepted by the classification symbol accepting and assigning unit 131 is compared with the classification symbol determined in STEP 511 (STEP 512), and the appropriateness of the classification symbol accepted in STEP 411 is verified (STEP 513).

(Advantageous Effects Exerted by Document Classification System 3)

The document classification system 3 includes: a first classifier that extracts a document including the keyword recorded in the keyword database from the document information, and assigns a specific classification symbol to the extracted document on the basis of the keyword correspondence information; and a second classifier that extracts the document including the related term recorded in the related term database from the document information assigned no specific classification symbol by the first classifier, calculates the score on the basis of the evaluated values of the related term and the number of related terms included in the extracted document, and assigns a predetermined classification symbol to the document having the score exceeding a certain value among the documents including the related term on the basis of the score and the related term correspondence information, thereby allowing the efforts of classification work by the reviewer to be reduced.

The document classification system of the present invention includes the classification symbol accepting and assigning unit that accepts assignment of the classification symbol from the user, has a function of extracting a word frequently appearing in documents with the common classification symbol assigned by the user and of analyzing the tendency information that is included in each document and is on the type of the extracted word and the evaluated value of each word and the number of appearances, and can automatically assign the classification symbol in consideration of the regularity of classification by the reviewer when the common classification symbol is assigned to the documents having the same tendency as the analyzed tendency information among the documents assigned no classification symbol by the classification symbol accepting and assigning unit.

The document classification system of present invention includes a language determiner and a translator which are for translating the language. Consequently, when the classification process of assigning the classification symbol to a document including multiple languages is performed, the effort of the user can be reduced.

In the case where the quality inspector is provided that determines the classification symbol to be assigned to the document to which the user has assigned the classification symbol, on the basis of the analyzed tendency information, compares the determined classification symbol with the classification symbol assigned by the user, and verifies the appropriateness, the present invention can detect an error of assignment of the classification symbol by the user.

According to the present invention, in the case where the second classifier has a function of recalculating the evaluated value of the related term using the calculated score and of weighting the evaluated value of the related term frequently appearing in a document with a score exceeding a certain value, the classification accuracy can be improved every time the document classification system executes the classification process.

### Embodiment 3

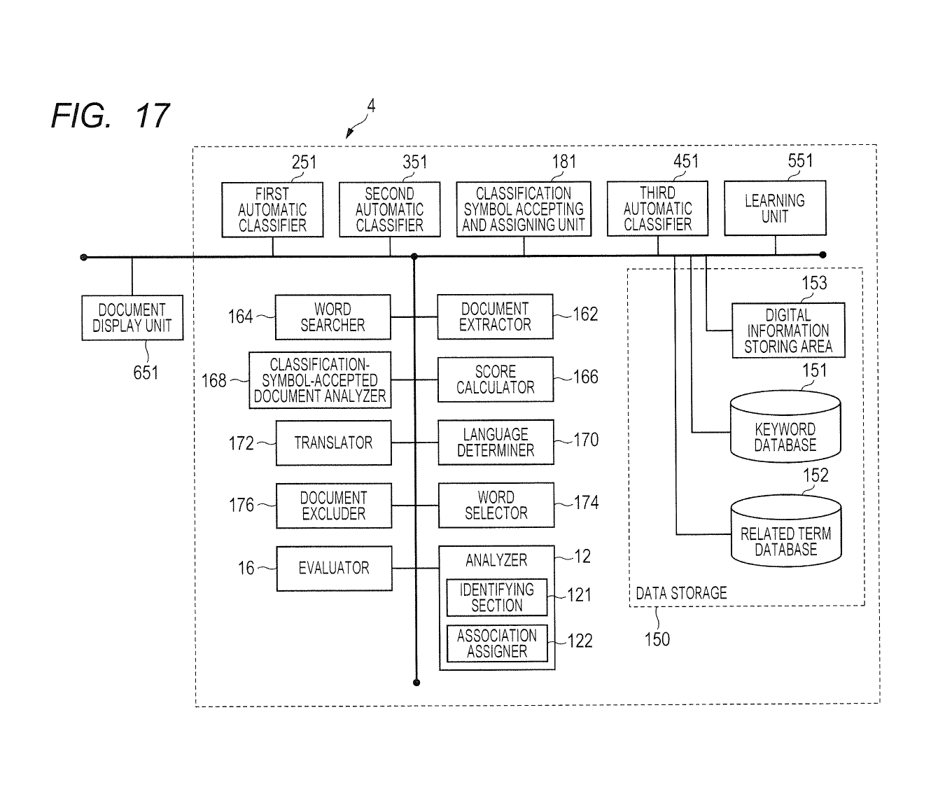

Referring to FIGS. 17 to 23, a third embodiment (Embodiment 3) according to the present invention is described. The following description is only for the functions and configuration that can be changed from those of Embodiments 1 and 2. The detailed description on the other functions and configuration is omitted because of similarity thereof to those in Embodiment 1 or 2.

(Configuration of Document Classification System 4)

FIG. 17 is a block diagram showing an example of a main configuration of a document classification system 4 according to Embodiment 3. The document classification system (data analysis system) 4 is a system that obtains digital information recorded in computers or servers, analyzes document information made up of multiple documents included in the obtained digital information, and assigns a classification symbol that indicates the degree of relevancy to a litigation, thereby facilitating use for the litigation.

As shown in FIG. 17, the document classification system 4 includes the analyzer 12 (the identifying section 121 and the association assigner 122) and the evaluator 16 which have been described in Embodiment 1. Consequently, the document classification system 4 exerts advantageous effects analogous to those of the aforementioned data analysis system 5.

That is, when work such as discovery is executed for example, the document classification system 4 can extract the action related to a predetermined case (litigation or fraud investigation) and identify the association with the data, thereby allowing a classification symbol representing the degree of relevancy to the case concerned to be accurately assigned. Consequently, the document classification system 4 can efficiently execute the discovery.

The analyzer 12 analyzes the content of documents extracted by a document extractor 112, thereby analyzing whether text having a relationship with the predetermined case is included in the documents or not.

When a first word that indicates a predetermined action is included in the text (data), the identifying section 121 identifies a second word that indicates an object of the predetermined action.

The association assigner 122 associates meta-information (attribute information) that indicates the attribute of the data including the first word and second word with the first word and second word.

The evaluator 16 evaluates the relationship between the content of the document and the predetermined case using the analysis result of the analyzer 12 (association assigner 122).

The document classification system 4 includes a data storage 150 that obtains digital information recorded in computers or servers to use the information for a litigation and stores the obtained digital information in a digital information storing area 153. The data storage 150 stores keyword database 151 where a specific classification symbol of a document included in the obtained digital information, a keyword having close relationship with the specific classification symbol, and keyword correspondence information that indicates the correspondence relationship between the specific classification symbol and the keyword are registered, and a related term database 152 where a predetermined classification symbol, a related term including a word having a high appearance frequency in the document assigned the predetermined classification symbol, and related term correspondence information that indicates the correspondence relationship between the predetermined classification symbol and the related term are registered. As shown in FIG. 17, the data storage 150 may be provided in the document classification system, or provided outside of the document classification system 4 as a separate storage device.

The document classification system 4 includes a document extractor 162 that extracts multiple documents from document information, a word searcher 164 that searches the document information for a keyword or a related term which is recorded in the database, and a score calculator 166 that calculates the score indicating the strength of connection between the document and the classification symbol. A process analogous to that of Embodiment 2 may be used for the process of calculating the score.

The document classification system 4 includes: a first automatic classifier 251 that causes the word searcher 164 to search for the keyword recorded in the keyword database 151, extracts a document including the keyword from the document information, and automatically assigns a specific classification symbol to the extracted document on the basis of the keyword correspondence information; and a second automatic classifier 351 that extracts, from the document information assigned no classification symbol, the document including the related term recorded in the related term database, calculates the score on the basis of the evaluated values and the number of related terms included in the extracted document, and automatically assigns a predetermined classification symbol to the document having the score exceeding a certain value on the basis of the score and the related term correspondence information.

The document classification system 4 further includes: a document display unit 651 that displays extracted multiple documents on the screen; a classification symbol accepting and assigning unit 181 that accepts the classification symbol assigned by a user to the documents to which the classification symbol extracted from the document information is not assigned, on the basis of the relevance to the litigation, and assigns the classification symbol; a classification-symbol-accepted document analyzer 168 that analyzes the document assigned the classification symbol by the classification symbol accepting and assigning unit 181; and a third automatic classifier 451 that automatically assigns the classification symbol to the multiple documents that have been assigned no classification symbol and extracted from the document information, on the basis of the analysis result of the document having been assigned the classification symbol by the classification symbol accepting and assigning unit 181.

As with the document classification system 3 according to Embodiment 2, the document classification system 4 may further include a language determiner 170 that determines the type of language of the extracted document, and a translator 172 that translates the extracted document upon acceptance of designation by the user or automatically.

The document classification system 4 includes a word selector 174 that analyzes and selects a keyword appearing in common in the group of extracted documents. The classification-symbol-accepted document analyzer 168 may analyze the document assigned the classification symbol by the classification symbol accepting and assigning unit 181, classify the document assigned the classification symbol according to each classification symbol, and analyze and select the keyword appearing in common in the group of classified document.

The document classification system 4 may include a document excluder 176 that searches text information which is to be a classification target that does not include any of the keyword and the related term preliminarily registered by the keyword database 151 and the related term database 152 and the keyword selected by the word selector 174, and preliminarily excludes the documents from classification targets.

The document classification system 4 may include a learning unit 551 that increase and reduce the keywords selected by the word selector 174 and the keywords and the related terms that have correlations with the classification symbol recorded in the database.

(Processes Executed by Document Classification System 4)

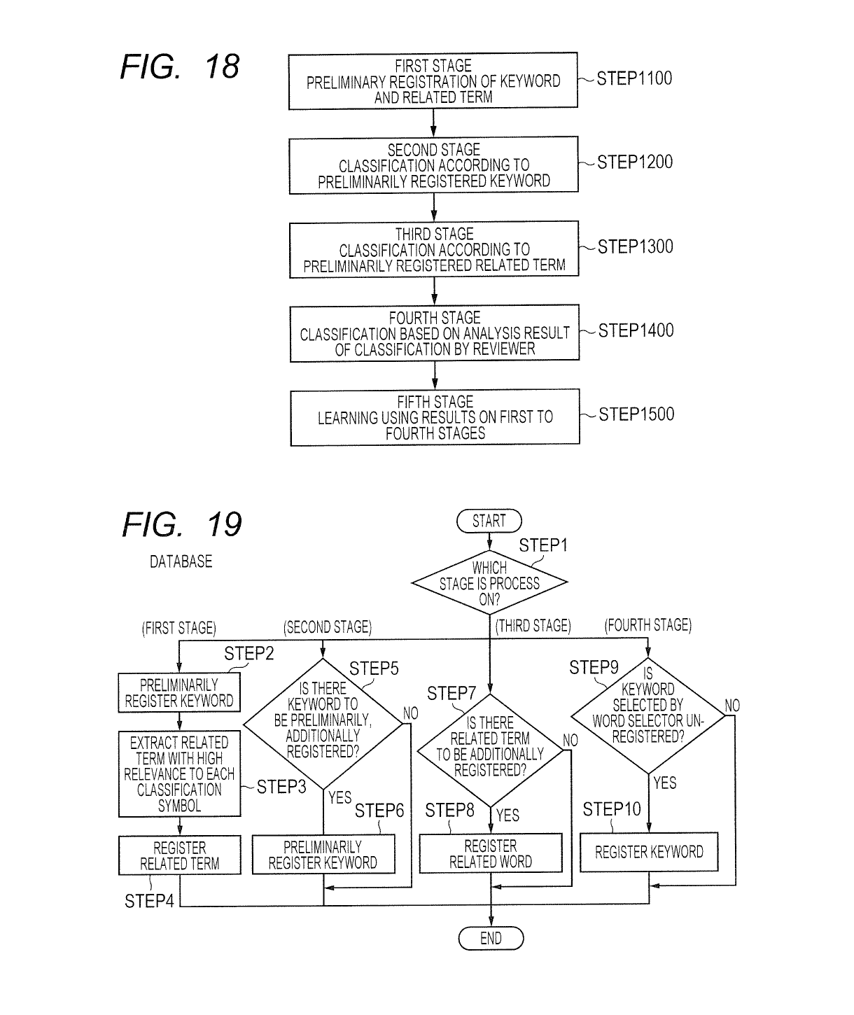

In Embodiment 3, according to a flowchart as shown in FIG. 18, a registration process, a classification process and a learning process are performed in five stages.

On the first step, the keyword and the related term are preliminarily registered using a result of a previous classification process. The keywords registered this time are keywords immediately assigned the symbol “important” upon being included in the document, and the keywords may be names of functions and the names of technologies regarded as an infringement action to the product A (STEP 1100).

On the second stage, the entire document information is searched for the document including the keyword registered on the first stage, and when the document is found, the symbol “important” is assigned (STEP 1200).

On the third stage, the entire document information is searched for the related term registered on the first stage, the score of the document including the related term is calculated, and the document is classified (STEP 1300).

On the fourth stage, determination of assignment of the classification symbol by the reviewer to the extracted document is accepted, the accepted determination of the assignment of the classification symbol is analyzed, and subsequently the classification symbol further extracted on the basis of the analysis result is automatically assigned to the document assigned no classification symbol (STEP 1400).

On the fifth stage, learning is performed using the results of the first to fourth stages (STEP 1500).

Each of the first to fifth stages of Embodiment 3 are described below further in detail.

<First Stage (STEP 1100)>

A processing flow of the keyword database 151 and the related term database 152 on the first stage is described in detail with reference to FIG. 19. The number of the stage on which the keyword database 151 and the related term database 152 execute the process is determined, and the process on the first stage is selected (STEP 1: first stage). On the first stage, first, the keyword is preliminarily registered in the keyword database 151 (STEP 2). What is registered at this time is a keyword which can be determined to have a high relevance to the product A and to be assigned the symbol “important” immediately upon being included in the document, according to the results of the previous classification processes. Likewise, according to the result of the previous classification processes, a general term having a high relevance to the group of documents assigned the symbol “important” because the relevance to the product A is high is extracted (STEP 3) and registered as a related term (STEP 4).

<Second Stage (STEP 1200)>

A processing flow of the keyword database 151, the word searcher 164 and the first automatic classifier 251 on the second stage is described in detail with reference to FIGS. 19, 20 and 22.

The number of the stage on which the process is performed on the database is determined, and the process on the second stage is selected (STEP 1: second stage). When a keyword required to be preliminarily registered is in the keyword database 151 (STEP 5: YES), additional registration is performed (STEP 6). In the case with no keyword to be additionally registered (STEP 5: NO) and after the completion of the process of STEP 6, the processing transitions to the process of the word searcher 164.

The word searcher 164 determines the number of the stage on which the process is performed, and selects the process on the second stage (STEP 11: second stage). On the second stage, first, the word searcher 164 determines whether there is a keyword preliminarily registered in the first and second stages in the keyword database 151 or not (STEP 12). When there is no preliminarily registered keyword (STEP 12: NO), the process on the second stage is finished.

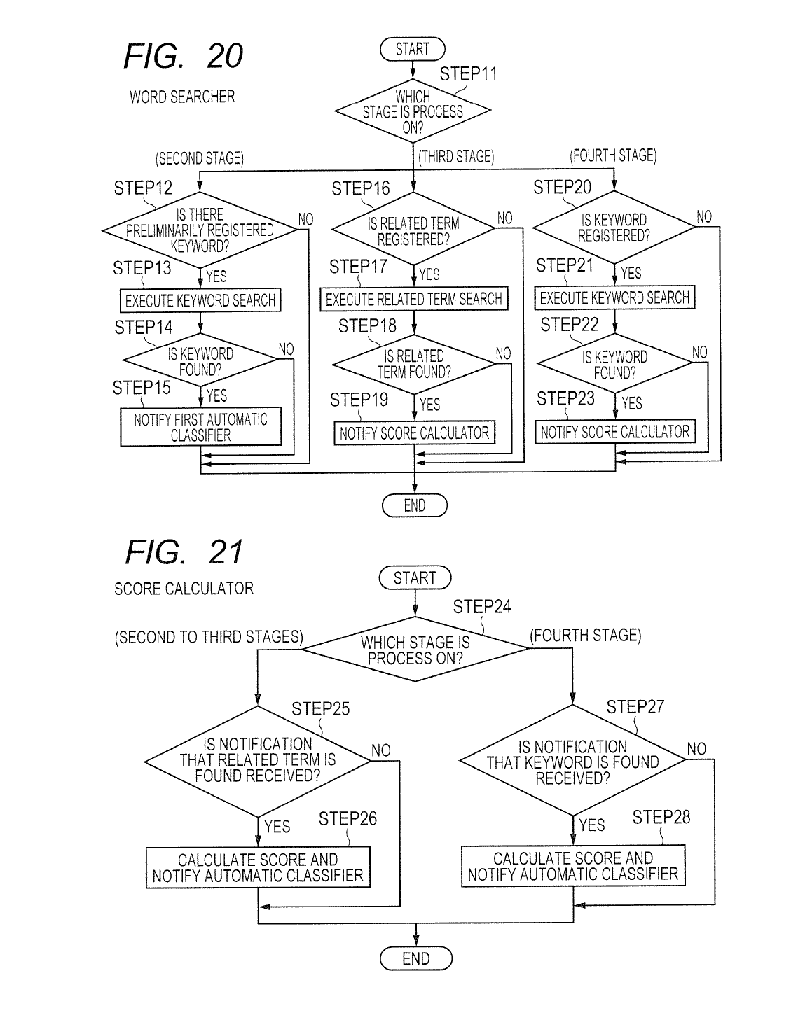

As shown in FIG. 20 (second stage), when there is a preliminarily registered keyword (STEP 12: YES), the entire document information that is to be a classification target is searched for a document including the keyword, in consideration of whether the document is in the document information to be the classification target or not (STEP 13). When there is no document including the keyword that is searched for (STEP 14: NO), the process on the second stage is finished. On the contrary, the document including the keyword that is searched for is found (STEP 14: YES), notification is issued to the first automatic classifier 251 (STEP 15).

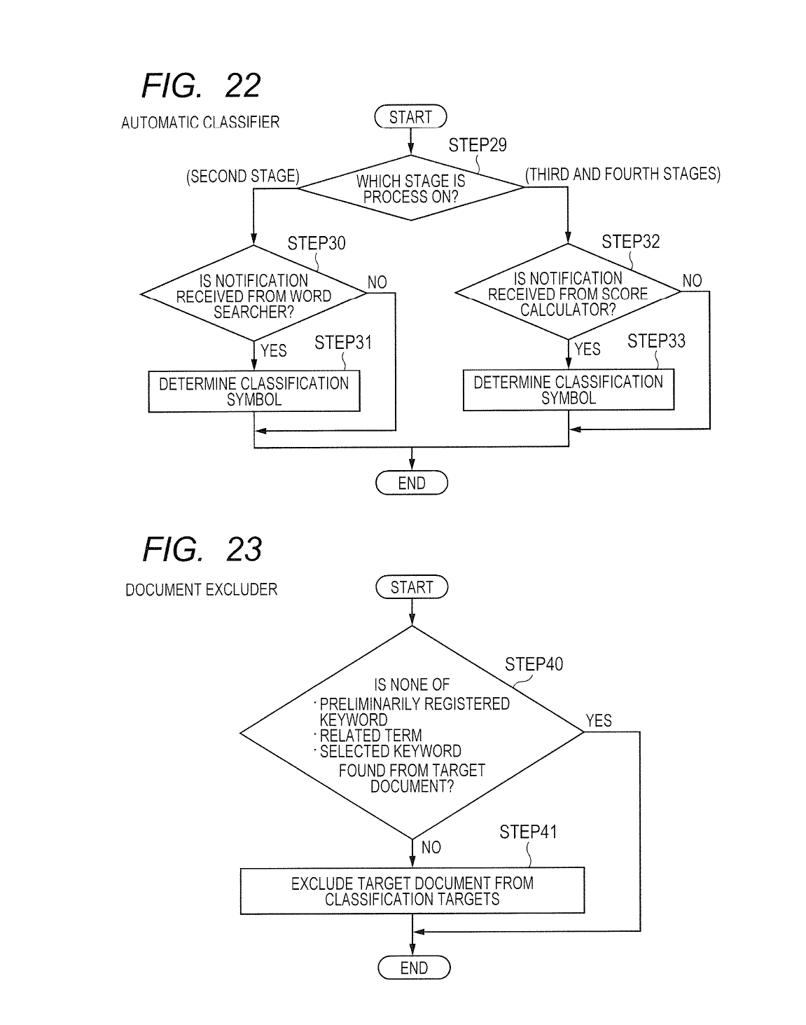

As shown in FIG. 22 (second stage), when the first automatic classifier 251 is received the notification from the word searcher 164 (STEP 29: the second stage, STEP 30: YES), the document that is the target of the notification is assigned the symbol “important” (STEP 31), and the processing is finished. When no notification is received from the word searcher 164 (STEP 29: the second stage, STEP 30: NO), no process is performed.

<Third Stage (STEP 1300)>

A processing flow of the related term database 152, the word searcher 164, the score calculator 166 and the second automatic classifier 351 on the third stage is described in detail with reference to FIGS. 19, 20, 21 and 22.

As shown in FIG. 19, the number of the stage on which the related term database 152 executes the process is determined, and the process on the third stage is selected (STEP 1: third stage). When a related term required to be preliminarily registered is in the related term database 152 (STEP 7: YES), additional registration is performed (STEP 8). When no additional registration of the related term is required (STEP 7: NO), the process on the third stage is finished.

After completion of the process of STEP 8 in the related term database 152, as shown in FIG. 20, the number of the stage on which the word searcher 164 executes the process is determined, and the process on the third stage is selected (STEP 11: third stage). On this stage, the word searcher 164 determines whether the related term preliminarily registered in the first and second stages in the related term database 152 exits or not (STEP 16). When there is no preliminarily registered related term (STEP 16: NO), the process on the third stage is finished.

When there is a preliminarily registered related term (STEP 16: YES), the entire document information that is to be a classification target is searched for a document including the related term, in consideration of whether the document is in the document information to be the classification target or not (STEP 17). When there is no document including the related term searched for (STEP 18: NO), the process on the third stage is finished. On the contrary, the document including the related term that is searched for is found (STEP 18: YES), notification is issued to the score calculator 166 (STEP 19).

As shown in FIG. 21, when the notification is received from the word searcher 164 (STEP 24: third stage, STEP 25: YES), the score calculator 166 calculates the score of each document on the basis of the type of the related term found in the document and the weight of the related term using the expression (1), and issues notification to the second automatic classifier 351 (STEP 26). When the notification on finding the related term is not received from the word searcher 164 (STEP 24: the third stage, STEP 25: NO), the process on the third stage is finished.

When the notification on the score is received from the score calculator 166 (STEP 29: third stage: STEP 32: YES), the second automatic classifier 351 determines whether the score exceeds the threshold or not on a document-by-document basis, assigns the symbol “important” to the document with a score exceeding the threshold, and when there is no document with a score exceeding the threshold, assignment is not performed, and the processing is finished (STEP 33).

<Fourth Stage (STEP 1400)>

A processing flow of the keyword database 151, the related term database 152, the word searcher 164, the score calculator 166 and the third automatic classifier 451 on the fourth stage is described with reference to FIGS. 19, 20, 21 and 22.

On the fourth stage, first, the document extractor 162 randomly samples documents from the document information that is to be a classification target, and extracts a group of documents that are targets to which the reviewer manually assigns the classification symbol. The document display unit 651 displays the group of extracted documents on the document display screen I1 of FIG. 16.

The reviewer reads the content of each document in the group of documents displayed on the document display screen I1 and then determines whether there is a relevance between the product A and the content of the document or not, and determines whether to assign the symbol “important” or not. The documents to which the reviewer assigns the symbol “important” include, for example, a report of results of prior art search about the product A, a letter of warning warned by another party that production of the product A infringes the patent.

The classification symbol assigned by the reviewer is accepted by the classification symbol accepting and assigning unit 181, and is processed in the document classification system 4. The classification-symbol-accepted document analyzer 168 classifies the documents according to the assigned classification symbol. Subsequently, the classification-symbol-accepted document analyzer 168 analyzes each document classified using the word selector 174 and the score calculator 166.

The word selector 174 performs keyword analysis to each of the classified documents, and selects a keyword having a high number of appearances in common to the documents assigned the symbol “important”.

Next, as shown in FIG. 19 (fourth stage), when the keyword selected by the word selector 164 has not been registered as a keyword related to the symbol “important” indicating the relationship with the product A (STEP 1: fourth stage, STEP 9: YES), the keyword database 151 registers the keyword (STEP 10). If the keyword has already been registered, no process is performed (STEP 1: fourth stage, STEP 9: NO).

If the keyword related to the symbol “important” has not been registered in the keyword database 151 (STEP 20: NO), the word searcher 164 finishes the process on the fourth stage. If the keyword has already been registered (STEP 20: YES), the documents extracted by the document extractor 162 and classified by the reviewer are omitted from the search target, and the keyword search is performed for the remaining documents as the targets (STEP 21). In the search, when the keyword is found in the document (STEP 22: YES), notification is issued to the score calculator 166 (STEP 23).

Upon receipt of the notification that the keyword is found is received (STEP 27: YES), the score calculator 166 calculates the score for each document using the expression (1), and notifies the third automatic classifier 451.

As shown in FIG. 22 (fourth stage), upon receipt of the notification from the score calculator 166 (STEP 32: YES), the third automatic classifier 451 determines whether the score exceeds the threshold or not on a document-by-document basis, assigns the symbol “important” to the document with a score exceeding the threshold, but does not assign the symbol to the document without exceeding, and the processing is finished (STEP 33).

<Fifth Stage (STEP 1500)>

The processes in the document excluder 176 and the learning unit 551 on the fifth stage are described as follows.

The document excluder 176 searches the group of documents to which the processes in the first to fourth stages have not been performed in the document information that is to be the classification target, about whether there is a document that includes the keywords preliminarily registered in the first and second stages, the related terms registered in the first and third stages, and the keyword registered in the fourth stage or not, and if there is a document where any of these items are not found (STEP 40: YES), this document is preliminarily excluded from the classification target (STEP 41).

The learning unit 551 learns the weighting of each keyword on the basis of the first to fourth processing results according to the expression (2). The learned result is reflected in the keyword database 151.

(Advantageous Effects Exerted by Document Classification System 4)

The document classification system, the document classification method and the document classification program according to the present invention extract, from document information, a document group that is a data set including a predetermined number of documents, display the extracted document group on a screen, accept a classification symbol assigned by a user on the basis of relevance to a litigation with respect to the displayed document group, classify the extracted document group for each classification symbol on the basis of the classification symbol, analyze and select a keyword appearing in common in the classified document group, record the selected keyword, search the document information for the recorded keyword, calculate a score representing relevance between the classification symbol and the document using the search result and the analysis result, and automatically assign the classification symbol on the basis of the score result, thereby allowing efforts of classification work by a reviewer to be reduced.

In the document classification system of the present invention, the searcher has a function of searching document information including documents assigned no classification symbol, for a keyword. The score calculator calculates the score representing relevance between the classification symbol and the document using the search result of the searcher and the analysis result of the selector. The automatic classifier extracts a document assigned no classification symbol by the classification symbol accepting and assigning unit. In the case where a function of automatically assigning the classification symbol to the document is provided, the document information on which assignment of the classification symbol is not accepted by the classification symbol accepting and assigning unit can be automatically assigned the classification symbol in consideration of the regularity of classification by the reviewer.

The document classification system of present invention includes a language determiner and a translator which are for translating the language. Consequently, when the classification process of assigning the classification symbol to a document including multiple languages is performed, the effort of the user can be reduced.

In the case where the present invention is provided with the learning unit that increases and reduces the keywords and the related terms having correlation with the classification symbol recorded in the database selected by the selector on the basis of the analysis result of the selector and the score calculated by the score calculator, the classification accuracy can be improved every time of repetition of classification.

According to the present invention, the database extracts and records a related term having relevance to the classification symbol. The searcher searches the document information for the related term. The score calculator calculates the score on the basis of the result of search for the related term by the searcher. The automatic classifier automatically assigns the classification symbol on the basis of the score calculated using the related term. A document that does not include the keyword selected by the selector or the keyword having correlation with the related term and the classification symbol is selected. When the selected document is excluded from the classification targets of the automatic classifier, the document classification can be more efficiently performed. This facilitates use of the collected digital information in a litigation.

### Embodiment 4

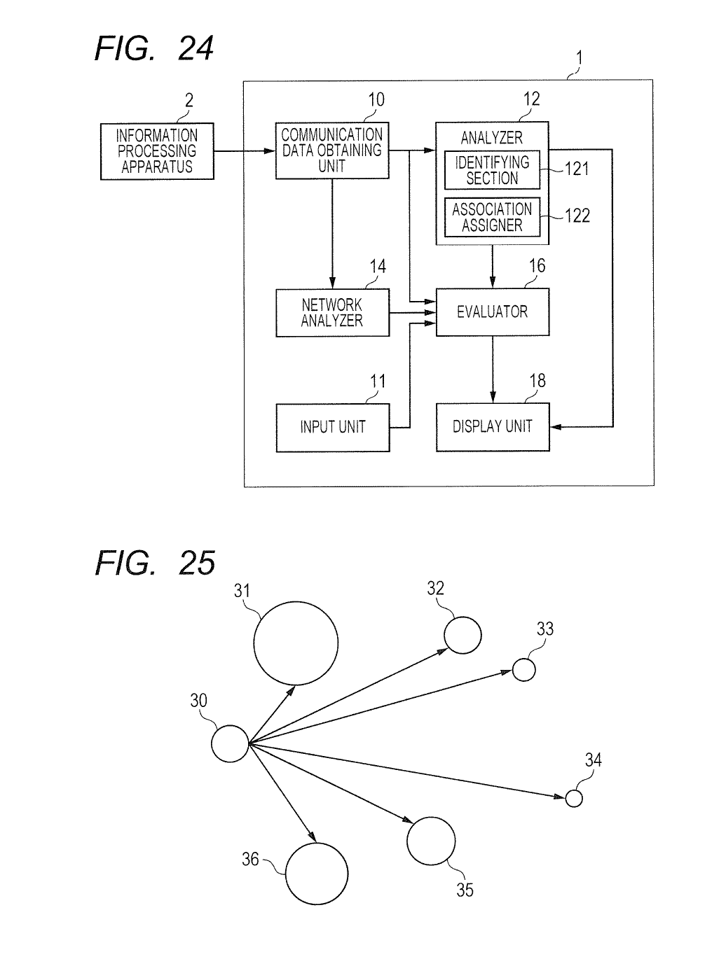

Referring to FIGS. 24 to 27, a fourth embodiment (Embodiment 4) according to the present invention is described. The following description is only for the functions and configuration that can be changed from those of Embodiments 1 to 3. The detailed description on the other functions and configuration is omitted because of similarity thereof to those in Embodiments 1 to 3.

(Overview of Correlation Display System 1)

FIG. 24 is a block diagram showing an example of a main configuration of a correlation display system 1 according to Embodiment 1. FIG. 25 is a diagram showing a display mode of a display unit included in the correlation display system 1.

The correlation display system (data analysis system) 1 analyzes a communication data item having relevance to a predetermined case among multiple communication data items (data, communication information) stored in an information processing apparatus 2, such as a user terminal or a server, thereby automatically displaying the relationship between people. The predetermined case is, for example, information that represents relationship with a litigation or fraud investigation (antitrust, patent, The Foreign Corrupt Practices Act (FCPA), product liability (PL), information leakage, billing fraud, etc.).

For example, the correlation display system 1 is applicable to a forensic technique that collects and analyzes digital information which is electronic records required to investigate and determine the cause of a crime or dispute, and clarifies the legal admissibility and competence of evidence, in case a crime or a legal dispute related to computers such as unauthorized access or classified information leakage occurs.

First, the correlation display system 1 analyzes the content of multiple communication data items transmitted and received between multiple information processing apparatuses 2, which are multiple terminals. Here, the communication data may include information indicating that the communication data has been transmitted from one person to another person. The communication data may include information for identifying a unit of an organization to which the one person belongs (e.g., subsection, section, division, company, etc.), and information for identifying a unit of an organization to which the other person belongs (e.g., subsection, section, division, company, etc.). Furthermore, the communication data is stored in the multiple information processing apparatuses 2, or a server connected to the information processing apparatuses 2 in a manner capable of communication.

In the analysis, when a first word that indicates a predetermined action is included in the communication data, the correlation display system 1 identifies a second word that indicates an object of the predetermined action. For example, when text “finalize the specifications” is included in the communication data, the words “specifications” and “finalize” are extracted from the text, the second word “specifications” (object) that is an object of the first word (verb) indicating a predetermined act “finalize” is identified.

Next, the correlation display system 1 associates meta-information (attribute information) that indicates an attribute (properties and characteristics) of the communication data including the first word and second word with the first word and second word. Here, the meta-information is information that indicates a predetermined attribute of the data. For example, in the case where the communication data is email, the meta-information may be the name of a person having transmitted the email, the name of a person having received the email, the email address, and the date and time of transmission and reception. In the case where the communication data is presentation materials, the meta-data may be the date and time of creation of the presentation materials.

For example, when the text “exchange technologies” is included in email (data, communication information) and words “technologies” (second word) and “exchange” (first word) are extracted (see the first row of the table shown in FIG. 2), the correlation display system 1 associates the “technologies” and “exchange” with the names of people (e.g., “person A” and “person B”) having transmitted and received the email. It can thus be estimated that “person A” and “person B” intend to “exchange” certain “technologies”.

Furthermore, for example, the text “finalize the specifications” is included in the presentation materials attached to the email and “specifications” (second word) and “finalize” (first word) are extracted (see the second row of the table shown in FIG. 2), the correlation display system 1 associates the “specifications” and “finalize” with the date and time of creation of the presentation materials (e.g., Jan. 16, 2014, 16:30). Consequently, it can be estimated that while “person A” and “person B” intend to “exchange” certain “technologies”, they try to “finalize” the “specifications” of the “technologies” at the time of Jan. 16, 2014, 16:30.

The correlation display system 1 displays the degree of exchange of information related to the predetermined case between the one person and the other person, or the degree of importance of information exchanged on information related to the predetermined case, on the basis of the analysis result, in a manner viewable by the user.

More specifically, the correlation display system 1 analyzes the content of communication data (e.g., email) transmitted and received between an information processing apparatus 2 belonging to the one person and an information processing apparatus 2 belonging to the other person. The correlation display system 1 then analyzes whether information related to the predetermined case is included in the content of the communication data or not. When the analysis result indicating that the information related to the case is included in the communication data is obtained, the correlation display system 1 evaluates the relevance between the communication data and the case. For example, the correlation display system 1 evaluates the degree of relevance of the content of the communication data to the case.

When the analysis result indicating presence of the relevance between the communication data and the case or the analysis result indicating the degree of relevance is obtained, the correlation display system 1 displays the relationship between the person and the other person on a monitor or the like. For example, the correlation display system 1 associates the people with respective nodes and displays the nodes on the monitor, and displays the one node and another node on the basis of the evaluation result (see FIG. 25).

For example, the correlation display system 1 connects and displays a node associated with one person and another node associated with another person to each other using an arrow indicating a flow of communication data. When the correlation display system 1 displays the one node and the other node, this system changes the forms of nodes according to the number of times or frequency of execution of exchanging information related to the predetermined case from the one node to the other node or according to the importance of the exchanged information, and displays the nodes.

For example, the correlation display system 1 changes the sizes, colors and/or shapes of the nodes and displays the nodes. The correlation display system 1 may change the thicknesses, colors and/or lengths of arrows that connect the nodes.

In Embodiment 1, the server is one or more servers. Alternatively, the configuration may include multiple servers. For example, the server may be a server that can store digital information, such as a mail server, a file server, or a document management server. The information processing apparatus 2, which serves as a terminal, may be one or more terminals. The configuration may include multiple information processing apparatuses 2. For example, the information processing apparatus 2 may be a personal computer, a notebook computer, a tablet PC, or a mobile communication terminal, such as a mobile phone, etc.

(Details of Correlation Display System 1)

The correlation display system 1 according to Embodiment 1 includes: a communication data obtaining unit 10 that obtains communication data transmitted and received between the information processing apparatuses 2; an analyzer 12 (identifying section 121 and association assigner 122) that analyzes the content of data obtained by the communication data obtaining unit 10; an evaluator 16 that evaluates the relationship between the communication data and the predetermined case using the analysis result of the analyzer 12; and a display unit 18 that displays the relationship between people on the basis of the evaluation result of the evaluator 16. The correlation display system 1 further includes: an input unit 11 that obtains information that associates the relationship of the predetermined case with a part of communication data obtained by the communication data obtaining unit 10; and a network analyzer 14 that determines multiple main terminals in a communication network made up of multiple terminals.

The correlation display system 1 and the information processing apparatus 2 are connected to each other in a manner capable of communication with each other by a communication network, such as the Internet, or wired or wireless network, such as an LAN. The correlation display system 1 may include some or all of functions and configuration elements included in the information processing apparatus 2. FIG. 24 shows one information processing apparatus 2. Alternatively, multiple information processing apparatuses 2 may be connected to the correlation display system 1 in a manner capable of communication.

The communication data obtaining unit 10 obtains communication data that is transmitted and received between the information processing apparatuses 2 serving as terminals and is associated with each of people. The communication data includes at least one of email, telephone call log, an access log to a social network service, information indicating identification of individual computers or servers (e.g., domain etc.) and the like. The communication data may include document file data attached to the communication data. The communication data is stored in the information processing apparatus 2 or a data server. The communication data obtaining unit 10 obtains multiple communication data items stored in the information processing apparatuses 2, or data servers. The communication data obtaining unit 10 supplies the obtained communication data to the analyzer 12 and the network analyzer 14.

The analyzer 12 analyzes the content of the communication data received from the communication data obtaining unit 10. More specifically, the analyzer 12 analyzes text data included in the content of the communication data, using the text mining method, image recognition method or the speech recognition method. The analyzer 12 then analyzes whether or not the content of the communication data includes text, an image or a sound that are related to the predetermined case.

Here, the predetermined case is information that indicates a relationship with a litigation, for example. The information may be not only the relationship with a litigation, but also correlation of human relations in fraud investigation, or what is related to correlation between people, accounting and technical information in M&A or intellectual property.

For example, the analyzer 12 includes a dictionary section that stores text data (including what has been converted into text using the image recognition method or speech recognition method) indicating words related to the predetermined case. The analyzer 12 analyzes the text data included in the content of the communication data using the text data stored in the dictionary section, thus analyzing whether the text related to the case is included in the content of the communication data or not.

When an analysis result indicating that the text is included is obtained, the analyzer 12 can assign information pertaining to the part of speech of the text to the text. Here, the parts of speech are information classified on the basis of the grammatical functions and morphology, and are, for example, noun, verb, adjective and the like. The analyzer 12 includes the identifying section 121 and the association assigner 122. The analyzer 12 outputs the analyzed result to the identifying section 121.

When a first word that indicates a predetermined action is included in the text (data), the identifying section 121 identifies a second word that indicates an object of the predetermined action. More specifically, the identifying section 121 determines whether the word included in the text is a verb (a word indicating a predetermined act) or not. When the word is a verb, the identifying section 121 identifies the second word (object) that is a target of the predetermined action and represented by the word concerned (first word). For example, when words “specifications” and “finalize” are extracted from the text “finalize the specifications”, the identifying section 22 identifies the second word “specifications” (object) that is an object of the first word (verb) indicating a predetermined act “finalize”. The identifying section 121 outputs the first word and the second word to the association assigner 122.

The association assigner 122 associates meta-information (attribute information) that indicates the attribute of the data including the first word and second word with the first word and second word. For example, when words “technologies” (second word) and “exchange” (first word) are input through the identifying section 121, the association assigner 122 associates the “technologies” and “exchange” with the names of people (e.g., “person A” and “person B”) having transmitted and received the communication data including the text. The association assigner 122 outputs the result of association to the evaluator 16.

The network analyzer 14 analyzes the communication network constructed by including multiple terminals, using the communication data, thereby determining main terminals in the communication network from among the terminals. For example, the network analyzer 14 determines the main terminals on the basis of the frequency of appearance of the terminals on the minimum paths between the terminals. For example, the network analyzer 14 determines the main terminals using vertex betweenness centrality and the like as an analysis algorithm. The network analyzer 14 supplies the evaluator 16 with information indicating the analysis result.

The evaluator 16 evaluates the relationship between the content of communication data and the predetermined case using the analysis result of the analyzer 12 (association assigner 122). The evaluator 16 can also use the communication data transmitted and received between the main terminals and the analysis result of the analyzer 12 to evaluate the relationship between the content of the communication data and the predetermined case. The evaluator thus evaluates the relationship using the communication data transmitted and received between the main terminals, thereby allowing narrowing down communication data items that have high relationship with the predetermined case and have been transmitted and received between the information processing apparatuses 2 from among the enormous communication data items.

For example, the evaluator 16 evaluates the relationship between the content of communication data and the predetermined case by executing an automatic code assigning process. For example, the evaluator 16 extracts some communication data items from among the communication data items obtained by the communication data obtaining unit 10. The evaluator 16 randomly extracts some communication data items from among the communication data items. Next, the evaluator 16 assigns the extracted data items a code that has been obtained by the input unit 11 from the outside and associates relationship with the predetermined case. The relationship with the predetermined case is information indicating that the communication data has the relationship with the predetermined case, information indicating the degree of relationship between the communication data and the predetermined case and the like.

The evaluator 16 then executes the automatic code assigning process to the entire communication data analyzed by the analyzer 12, or the entire communication data analyzed by the analyzer 12 that the text data related to the predetermined case is included, using the communication data code assigned the information associating the relationship with the predetermined case. Consequently, the evaluator 16 evaluates whether the communication data transmitted from the information processing apparatus of the one person to the information processing apparatus of the other person is related to the predetermined case or not, and the degree of relevance of the communication data with the predetermined case. Alternatively, the evaluator 16 may evaluate whether the communication data transmitted from the information processing apparatus of one domain to the information processing apparatus of the other domain information is related to the predetermined case or not, and the degree of relevance of the communication data with the predetermined case. The domain information may be information representing the identities of individual computers, or identifiers after the @ mark in email.

For example, the evaluator 16 evaluates whether email transmitted from an information processing apparatus of a first person to an information processing apparatus of a second person is related to the predetermined case or not. When the email is related to the case, the evaluator 16 associates a score with the email. Likewise, the evaluator 16 associates scores with all pieces of the email transmitted from the information processing apparatus of the first person to the information processing apparatus of the second person, and adds up the associated scores, thus calculating the score of relationship between the first person and the second person. Likewise, the evaluator 16 evaluates every piece of email transmitted from an information processing apparatus of one person to each of information processing apparatuses of other people. The evaluator 16 calculates scores for the respective relationships between the one person and the other people, and performs evaluation.

The evaluator 16 also evaluates whether email transmitted from an information processing apparatus in a first domain to an information processing apparatus in a second domain is related to the predetermined case or not. When the email is related to the case, the evaluator 16 associates a score with the email. Likewise, the evaluator 16 associates scores with all pieces of the email transmitted from the information processing apparatus in the first domain to the information processing apparatus in the second domain, and adds up the associated scores, thus calculating the score of relationship between the first domain and the second domain. Likewise, the evaluator 16 evaluates every piece of email transmitted from an information processing apparatus in one domain to each of information processing apparatuses in other domains. The evaluator 16 calculates scores for the respective relationships between the one domain and the other domains, and performs evaluation.

When the evaluator 16 evaluates the relationship on the basis of the communication data analysis result, the evaluation is executed as follows, for example. First, the evaluator 16 may include a dictionary that associates the combinations of words related to the predetermined case with scores indicating the degrees of relevance with the predetermined case, and stores the associated combinations. The evaluator 16 then analyzes text data in the communication data on the basis of morphological analysis, and determines whether the combination of words stored in the dictionary is included in the selected communication data or not.

When the evaluator 16 determines that the combination of words stored in the dictionary is included in the selected communication data, this evaluator evaluates the degree of relevance of the file to the predetermined case on the basis of the score stored in the dictionary. The evaluator 16 then associates the information representing the evaluation result (i.e., the degree of relevance to the predetermined case) with the selected communication data. The evaluator 16 can thus evaluate the degree of relationship between the communication data and the predetermined case.

Furthermore, the evaluator 16 can evaluate the degree of relevance of the communication data to the predetermined case on every communication data transmission and reception times through reading the transmission and reception times included in the communication data. The evaluator 16 can also evaluate the degree of relevance of the communication data to the predetermined case on every execution time when the evaluation is performed. The evaluator 16 supplies the display unit 18 with information representing the evaluation result.

The display unit 18 displays the relationship between people related to the predetermined case on the basis of the evaluation result of the evaluator 16. The display unit 18 can change the display form according to the score calculated by the evaluator 16 for the relationship between the one person and the other person.

For example, the display unit 18 analyzes the evaluation result received from the evaluator 16, and grasps each of people related to the predetermined case. As shown in FIG. 25, the display unit 18 associates people with respective circular nodes, and displays the nodes, and when there is relationship between one person and another person, this unit connects the node corresponding to the one person and the node corresponding to the other person to each other with an arrow and displays the nodes and arrow. The size of each node represents the degree of relationship with one node 30. That is, it is represented that the larger the size of the node is, the higher the relationship with the node 30 is. In the example of FIG. 25, the sizes of the nodes decrease in order of a node 31, node 36, node 35, node 32, node 33 and node 34. Consequently, in the example of FIG. 25, the relationship with the person corresponding to the node 30 is high in order of the node 31, node 36, node 35, node 32, node 33 and node 34. The display unit 18 may display the score calculated by the evaluator 16 in the node.

The display unit 18 may change the thickness, color and the like of the arrow or line segment that connects the nodes to each other and display the changed item. For example, the display unit 18 changes the thickness, color, line type, or length of line of the arrow or line segment according to the relationship between a person associated with one node and a person associated with another node. For example, the higher the relationship between the person associated with one node and the person associated with another node is, the thicker or with a more emphasized color the display unit 18 displays the line segment to represent the state of connection between the one node and the other node (e.g., a black line is displayed in a normal state, and a red or yellow line is displayed in an emphasized state).

Furthermore, the display unit 18 can not only associate one person (i.e., an individual) with one node, but also associate a predetermined organization unit (e.g., subsection, section, division, company, etc.) with one node. In this case, the analyzer 12 analyzes the content of the communication data, and groups the multiple communication data items according to predetermined organization units. The analyzer 12 supplies the display unit 18 with information representing the grouped result.

The display unit 18 can display a first relationship between people on the basis of the analysis result of the analyzer 12, and subsequently display a second relationship between people where the evaluation result of the evaluator 16 is reflected in the first relationship. That is, first, the display unit 18 displays the first relationship on the basis only of the analysis result of the analyzer 12 using the text mining. Subsequently, on a stage where the evaluation result of the evaluator 16 is automatically generated using the automatic code assigning process, the display unit 18 can change the first relationship to the second relationship using the evaluation result and display the second relationship.

The display unit 18 can dynamically change the display of the relationship between people on the basis of the evaluation result of the evaluator 16 according to units of transmission and reception times or units of execution time. For example, the display unit 18 displays the amount of transmission and reception of communication data (e.g., email) between the nodes every predetermined time interval in a manner viewable by the user. For example, the display unit 18 displays the amount of communication data exchanged between the nodes along the time series with the size of the node and the thickness of line being changed. Consequently, the display unit 18 can display, in an emphasized manner, the relationship between people where the amount of transmission and reception is rapidly increasing after a predetermined time. Consequently, the correlation display system 1 can identify the people whose amount of communication data transmitted and received is rapidly increasing after occurrence of a predetermined incident.

The display unit 18 can display the relationship between people every time the evaluation of the evaluator 16 is executed. That is, the display unit 18 can display dynamically change in real time the relationship between people every time the evaluation of the evaluator 16 is executed and the evaluation result is changed. Alternatively, the display unit 18 may perform display including the nodes with the domain information instead of the people. In the case of domain information, the analyzer 18 may perform analysis so as to include the nodes representing the people in the node 31. The display unit 18 may represent the node representing the people in the node of the domain information on the basis of the analysis result. Alternatively, the display unit 18 may display the relationship between pieces of domain information related to the predetermined case on the basis of the evaluation result of the evaluator 16.

(Overview of Correlation Display Method)

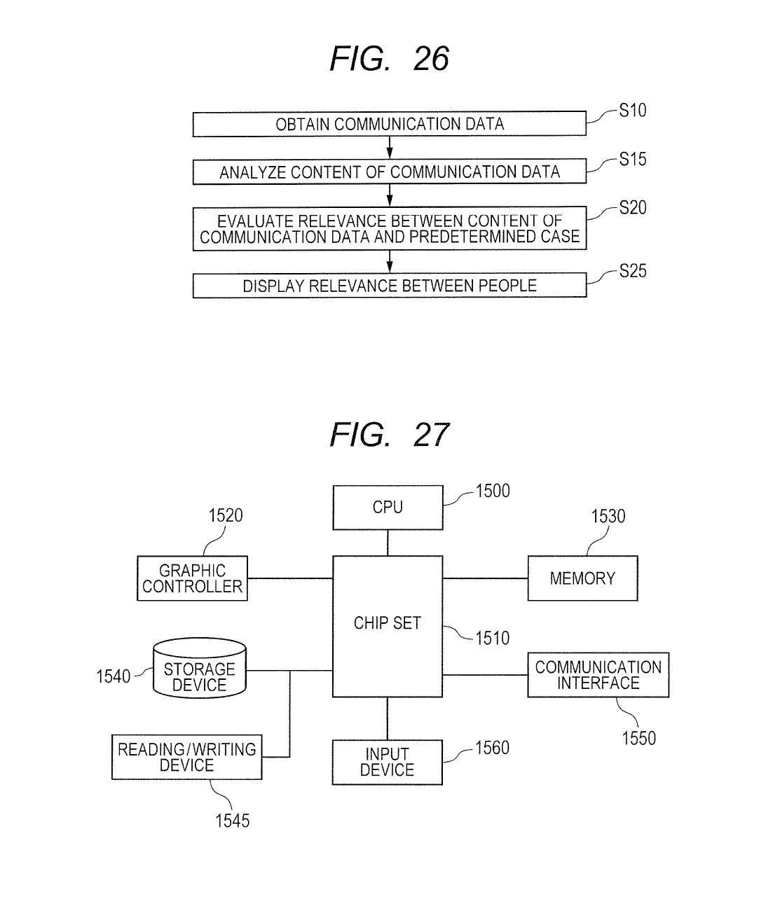

FIG. 26 is a flowchart showing a flow of processes executed by the correlation display system 1. First, the communication data obtaining unit 10 obtains communication data from the information processing apparatus 2 or the server that stores the communication data, which has been transmitted and received between the information processing apparatuses 2 (STEP 10; hereinafter, “STEP” is represented as “S”). The communication data obtaining unit 10 supplies the communication data to the analyzer 12, the network analyzer 14 and/or the evaluator 16, in response to approaches from the analyzer 12, the network analyzer 14 and the evaluator 16.

The analyzer 12 analyzes the content of the communication data obtained from the communication data obtaining unit 10 (S15). For example, the analyzer 12 analyzes the content of text data included in the communication data, using the text mining method. For example, the analyzer 12 analyzes whether the word related to the predetermined case is included in the communication data or not. The identifying section 121 and the association assigner 122 included in the analyzer 12 may execute, in S15, the process shown in FIG. 3. The analyzer 12 supplies the analysis result to the evaluator 16 and the display unit 18.

The evaluator 16 evaluates the relationship between the content of the communication data and the predetermined case (S20). The evaluator 16 evaluates the relationship using the method of the automatic code assigning process, for example. The evaluator 16 supplies the evaluation result to the display unit 18. The display unit 18 displays the relationship between people on an output device, such as a monitor, in a manner viewable by the user, on the basis of the evaluation result received from the evaluator 16 (S25).

(Hardware Configuration of Correlation Display System 1)

FIG. 27 shows an example of a hardware configuration of the correlation display system 1. The correlation display system 1 includes: a CPU 1500, a graphic controller 1520; a memory 1530, such as RAM (Random Access Memory), ROM (Read-Only Memory) and/or flash ROM; a storage device 1540 that stores data; a reading/writing device 1545 that reads data from a recording medium and/or writes data into the recording medium; an input device 1560 through which data is input; a communication interface 1550 that transmits and receives data to and from external communication equipment; and a chip set 1510 that connects the CPU 1500, the graphic controller 1520, the memory 1530, the storage device 1540, the reading/writing device 1545, the input device 1560, and the communication interface 1550 to each other in a manner capable of communication with each other.

The chip set 1510 connects the memory 1530, the CPU 1500 that accesses the memory 1530 and executes a predetermined process, and the graphic controller 1520 that controls display on an external display device to each other, thereby executing exchange of data between the configuration elements. The CPU 1500 operates on the basis of a program stored in the memory 1530, and controls each configuration element. The graphic controller 1520 displays an image on the predetermined display device on the basis of image data temporarily stored in a buffer provided in the memory 1530.

The chip set 1510 connects the storage device 1540, the reading/writing device 1545, and the communication interface 1550. The storage device 1540 stores the program and data used by the CPU 1500 of the correlation display system 1. The storage device 1540 is, for example, a flash memory. The reading/writing device 1545 reads the program and/or data from the storage device that stores the program and/or data, and stores the read program and/or data in the storage device 1540. The reading/writing device 1545 obtains a predetermined program from a server in the Internet via the communication interface 1550, for example, and stores the obtained program in the storage device 1540.

The communication interface 1550 transmits and receives data to and from an external apparatus via the communication network. In case the communication interface is blocked, the communication interface 1550 can transmit and receive the data to and from the external apparatus without intervention of the communication interface. The input device 1560, such as a keyboard, a tablet and a mouse, is connected to the chip set 1510 via a predetermined interface.

A correlation display program stored in the storage device 1540 for the correlation display system 1 is provided for the storage device 1540 via a communication network, such as the Internet, or a recording medium, such as a magnetic recording medium or an optical recording medium. The program for the correlation display system 1 stored in the storage device 1540 is executed by the CPU 1500.

The correlation display program executed by the correlation display system 1 according to Embodiment 1 approaches the CPU 1500 to cause the correlation display system 1 to function as the communication data obtaining unit 10, the input unit 11, the analyzer 12, the identifying section 121, the association assigner 122, the network analyzer 14, the evaluator 16, and the display unit 18, which have been described in FIGS. 24 to 27.

(Advantageous Effect Exerted by Correlation Display System 1)

The correlation display system 1 can extract the parts (first word and second word) related to the human action from the predetermined data, and associate the extracted parts with the meta-information, thereby allowing the human action to be analyzed. For example, when text “exchange technologies” is included in email (data, communication information) and words “technologies” (second word) and “exchange” (first word) are extracted, the correlation display system 1 associates the “technologies” and “exchange” with the names of people (e.g., “person A” and “person B”, i.e., meta-information representing the attribute of data) having transmitted and received the email. It can thus be estimated that “person A” and “person B” intend to “exchange” certain “technologies”.

Consequently, when work such as discovery is executed for example, the correlation display system 1 can extract the action related to a predetermined case (litigation or fraud investigation) and identify the association with the data, thereby allowing the discovery to be efficiently executed. Furthermore, the correlation display system 1 can grasp the relationship between people having high relevance to a predetermined case. Consequently, oversight of important communication data in work, such as discovery, can be prevented.

The correlation display system, method and program according to the embodiments of the present invention may display not only the relationship between people, but also the relationship between pieces of domain information, post information in an organization, gender information, nationalities, phone communication information, chat information and the like.

### Other Embodiments

Other embodiments of the present invention are described.

In the aforementioned embodiments, examples in a patent infringement litigation have particularly been described. The document classification system according to the present invention can be used in any litigation with obligation to submit documents based on adoption of eDiscovery (electronic discovery) system through the anti-cartel or antitrust law.

In Embodiment 2 or 3, the process on the fourth stage that automatically assigns the classification symbol in consideration of the regularity of classification by the reviewer is executed after the first to third stages. Only the process on the fourth stage is solely executed without execution of the processes on the first to third stages.

Furthermore, first, the document extractor extracts a partial document group from the document information, and the process on the fourth stage is executed to the extracted document group at the beginning. An embodiment may be adopted that subsequently executes the processes on the first to third stages on the basis of the keyword registered on the fourth stage.

On the fourth stage in Embodiment 3, the word searcher 164 searches the documents where no classification symbol has been accepted by the classification symbol accepting and assigning unit 181, with the keyword selected by the word selector 174. Alternatively, the entire document information may be keyword-searched.

On the fourth stage in Embodiments 2 and 3, the third automatic classifiers 401 and 451 regard the documents where no classification symbol is accepted in the classification symbol accepting and assigning units 131 and 181, as targets of automatic assignment of the classification symbol. Alternatively, the entire document information may be the target of automatic assignment.

The document classification system, the document classification method and the document classification program according to the second embodiment of the present invention extract, from document information, a document group that is a data set including a predetermined number of documents, display the extracted document group on a screen, accept a classification symbol assigned by the reviewer on the basis of relevance to a litigation with respect to the displayed document group, classify the extracted document group for each classification symbol on the basis of the classification symbol, analyze and select a keyword appearing in common in the classified document group, record the selected keyword, search the document information for the recorded keyword, calculate the score representing relevance between the classification symbol and the document using the search result and the analysis result, and automatically assign the classification symbol on the basis of the score result, thereby allowing efforts of classification work by a reviewer to be reduced.

In the document classification system according to the second embodiment of the present invention, the word searcher has a function of searching document information including documents assigned no classification symbol, for a keyword. The score calculator calculates the score representing relevance between the classification symbol and the document using the search result of the searcher and the analysis result of the selector. The automatic classifier extracts a document where assignment of the classification symbol is not accepted by the classification symbol accepting and assigning unit. In the case where a function of automatically assigning the classification symbol to the document is provided, the document information on which assignment of the classification symbol is not accepted by the classification symbol accepting and assigning unit can be automatically assigned the classification symbol in consideration of the regularity of classification by the reviewer.

In the case where the second embodiment is provided with the learning unit that increases and reduces the keywords and the related terms having correlation with the classification symbol recorded in the database selected by the selector on the basis of the analysis result of the selector and the score calculated by the score calculator, the classification accuracy can be improved every time of repetition of classification.

According to the second embodiment, the database extracts and records a related term having relevance to the classification symbol. The word searcher searches the document information for the related term. The score calculator calculates the score on the basis of the result of search for the related term by the searcher. The automatic classifier automatically assigns the classification symbol on the basis of the score calculated using the related term. A document that does not include the keyword selected by the selector or the keyword having correlation with the related term and the classification symbol is selected. When the selected document is excluded from the classification targets of the automatic classifier, the document classification can be more efficiently performed. This facilitates use of the collected digital information for a litigation.

[Implementation Example Through Program]

The blocks included in the correlation display system 1, the document classification system 3, the document classification system 4, and the data analysis system 5 may be implemented by logic circuits (hardware) formed on an integrated circuit (IC chip) and the like or software through use of CPU (Central Processing Unit). In the latter case, the correlation display system 1, the document classification system 3, the document classification system 4, and the data analysis system 5 include a CPU that executes instructions of a program (control program) that are software implementing each function, ROM (Read Only Memory) or a storage device (which is called a “recording medium”) where the program and various data items are recorded in a manner readable by a computer (or CPU), and RAM (Random Access Memory) where the program is deployed. The computer (or CPU) reads the program from the recording medium and executes the program, thereby achieving the object of the present invention. The recording medium may be a “non-transitory, tangible medium”, for example, a tape, a disk, a card, a semiconductor memory, a programmable logic circuit, etc. The program may be supplied to the computer via any transmission medium (communication network, broadcast waves, etc.) that can transmit the program. The present invention can be achieved in a form of a data signal embedded in carrier waves implemented through electronic transmission of the program.

[Supplement Item 1]

The embodiments of the present invention have been described above. However, the embodiments do not limit the invention according to the claims. It should be noted that not all the combinations of characteristics described in the embodiments are necessarily required for means for solving the problems. The technical elements of the embodiments may be solely applied. Alternatively, the elements may be divided into multiple parts which are program components and hardware components and applied.

[Supplement Item 2]

A correlation display system includes: a communication data obtaining unit that obtains communication data transmitted and received between terminals and associated with each of people; an analyzer that analyzes the content of the communication data obtained by the communication data obtaining unit; an evaluator that evaluates a relationship between content of the communication data and a predetermined case using an analysis result of the analyzer; and a display unit that displays a relationship between people related to the case, based on an evaluation result of the evaluator.

A correlation display system includes: a communication data obtaining unit that obtains communication data transmitted and received between terminals and associated with each of people; an analyzer that analyzes domain information on the communication data obtained by the communication data obtaining unit; an evaluator that evaluates a relationship between the domain information on the communication data and a predetermined case using an analysis result of the analyzer; and a display unit that displays the domain information related to the case, based on an evaluation result of the evaluator.

The correlation display system further includes a network analyzer that analyzes a communication network constructed by including the terminals, using the communication data, thereby determining main terminals in the communication network among the terminals, wherein the evaluator evaluates the relationship using the communication data transmitted and received between the main terminals and the analysis result.

In the correlation display system, the display unit displays a first relationship between the people on the basis of the analysis result, and subsequently displays a second relationship between the people where the evaluation result is reflected in the first relationship.

In the correlation display system, the evaluator evaluates the relationship every time of transmission and reception times of the communication data, or every execution time when the evaluation is executed, and the display unit changes and displays the relationship between people or the domain information, based on the evaluation result of the evaluator every time of transmission and reception times or every execution time.

In the correlation display system, the communication data includes at least one of email, a telephone call log, and an access log to a social network service.

In the correlation display system, the predetermined case is information that indicates a relationship with a litigation.

A correlation display method includes: a communication data obtaining step of obtaining communication data transmitted and received between terminals and associated with each of people; an analyzing step of analyzing the content of the communication data obtained by the communication data obtaining step; an evaluating step of evaluating a relationship between content of the communication data and a predetermined case using an analysis result of the analyzing step; and a displaying step of displaying a relationship between the people, based on an evaluation result of the evaluation step.

A correlation display program causes a computer to achieve a communication data obtaining function of obtaining communication data transmitted and received between terminals and associated with each of people; an analyzing function of analyzing the content of the communication data obtained by the communication data obtaining function; an evaluating function of evaluating a relationship between content of the communication data and a predetermined case using an analysis result of the analyzing function; and a displaying function of displaying a relationship between the people related to the case, based on an evaluation result of the evaluation function.

A correlation display method includes: a communication data obtaining step of obtaining communication data transmitted and received between terminals and associated with each of people; an analyzing step of analyzing domain information on the communication data obtained by the communication data obtaining step; an evaluating step of evaluating a relationship between the domain information on the communication data and a predetermined case using an analysis result of the analyzing step; and a displaying step of displaying a relationship of the domain information, based on an evaluation result of the evaluation step.

A correlation display program causes a computer to achieve a communication data obtaining function of obtaining communication data transmitted and received between terminals and associated with each of people; an analyzing function of analyzing domain information on the communication data obtained by the communication data obtaining function; an evaluating function of evaluating a relationship between the domain information of the communication data and a predetermined case using an analysis result of the analyzing function; and a displaying function of displaying a relationship of the domain information related to the case, based on an evaluation result of the evaluation function.

[Supplement Item 3]

A document classification system that obtains digital information recorded in computers or servers, analyzes document information including multiple documents included in the obtained digital information, and assigns the document a classification symbol that represents a degree of relevancy to a litigation so as to facilitate use for the litigation, includes: a document data storage for holding document information included in the obtained digital information, the storage storing the document information, while storing a keyword database where a predetermined classification symbol, a keyword described in the document assigned the predetermined classification symbol, and keyword correspondence information that represents correspondence relationship between the specific classification symbol and the keyword are registered, and a related term database where a predetermined classification symbol, a related term including a word having a high appearance frequency in the document assigned the predetermined classification symbol, and related term correspondence information representing correspondence relationship between the predetermined classification symbol and the related term; a first automatic classifier that causes the word searcher to search for the keyword recorded in the keyword database, extracts a document including the keyword from the document information, and automatically assigns the specific classification symbol to the extracted document, based on the keyword correspondence information; a score calculator that calculates a score representing strength of connection between the document and the classification symbol; a second automatic classifier that extracts a document including the related term recorded in the related term database from the document information, calculates a score based on an evaluated value of the related term included in the extracted document and the number of related terms, and automatically assigns the predetermined classification symbol to the document having the score exceeding a certain value among the documents including the related term, based on the score and the related term correspondence information; a classification symbol accepting and assigning unit that accepts the classification symbol assigned by a user based on relevance to the litigation for documents assigned no classification symbols extracted from the document information, and assigns the classification symbol to the documents; a classification-symbol-accepted document analyzer that analyzes the documents assigned the classification symbol by the classification symbol accepting and assigning unit; and a third automatic classifier that automatically assigns the classification symbol to the documents assigned no classification symbol extracted from the document information, based on an analysis result of the document assigned the classification symbol by the classification symbol accepting and assigning unit.

A document classification system includes: a language determiner that determines the type of language of the extracted document; and a translator that translates the document extracted from the document information upon acceptance of designation by a user or automatically.

The document classification system further includes a tendency information generator that generates tendency information that represents a degree of similarity with the document assigned the classification symbol included in each document, based on the type of a word included in each document, the number of appearances, and the evaluated value of the word, wherein the classification-symbol-accepted document analyzer extracts the word frequently appearing in the documents having the common classification symbol assigned by the user, and analyzes the extracted type of word, the evaluated value of each word, and the number of appearances included in each document on a document-by-document basis to thereby allow the tendency information generator to generate the tendency information, and assigns the common classification symbol to the document having the same tendency as the tendency information generated by the analysis among the documents where no classification symbol is not accepted by the classification symbol accepting and assigning unit.

The document classification system further includes a quality inspector that determines the classification symbol to be assigned to the document to which the user has assigned the classification symbol, on the basis of the analyzed tendency information, compares the determined classification symbol with the classification symbol assigned by the user, and verifies the appropriateness.

In the document classification system, the first classifier selects the classification symbol to be assigned to the document including the keywords, based on the evaluated value and the number of appearances of the keywords.

In the document classification system, the second classifier recalculates the evaluated value of the related term using the calculated score, and weights the evaluated value of the related term frequently appearing in the document having the score exceeding a certain value.

A document classification system includes a word selector that selects a word, wherein the classification-symbol-accepted document analyzer classifies and analyzes the document assigned the classification symbol by the classification symbol accepting and assigning unit with respect to each classification symbol, and the word selector is used to select the word appearing in common in the group of classified document, and the third automatic classifier assigns the classification symbol to the document assigned no classification symbol, based on the selected word.

A document classification system includes a word selector that selects a word, wherein the classification-symbol-accepted document analyzer classifies and analyzes the document assigned the classification symbol by the classification symbol accepting and assigning unit with respect to each classification symbol, the word selector is used to select the word appearing in common in the group of classified document, the score calculator calculates the score representing the relevance between the classification symbol and the document using a selection result of the word selector and an analysis result of the classification-symbol-accepted document analyzer, and the third automatic classifier assigns the classification symbol to the document assigned no classification symbol, based on the selected word.

The document classification system selects a keyword as the word.

The document classification system selects a related term as the word.

The document classification system further includes a document excluder that selects a document that does not include the keyword selected by the word selector, nor the keyword having the correlation with the related term and the classification symbol among the documents included in the document group, and excludes the selected documents from classification targets of the third automatic classifier.

The document classification system further includes a learning unit that increases and reduces the keywords selected by the selector, the keywords and the related words having the correlation with the classification symbol recorded in the database based on the analysis result of the selector and the score calculated by the score calculator.

In the document classification system, the score calculator calculates the score, based on the keyword appearing in the document group, and the weight of each keyword.

In the document classification system, the weighting is determined based on the amount of transmitted information of the keyword with respect to each classification symbol.

In the document classification system, the document extractor has a function of randomly sampling and extracting the document group from the document information.

In a document classification method that obtains digital information recorded in computers or servers, analyzes document information including multiple documents included in the obtained digital information, and assigns the document a classification symbol that represents a degree of relevancy to a litigation so as to facilitate use for the litigation, a computer records a specific classification symbol, a keyword described in the document assigned the specific classification symbol, and keyword correspondence information representing correspondence relationship between the specific classification symbol and the keyword, in a keyword database, records a predetermined classification symbol, a related term including a word having a high appearance frequency in the document assigned the predetermined classification symbol, and related term correspondence information representing correspondence relationship between the predetermined classification symbol and the related term, in a related term database, extracts a document including the recorded keyword from the document information, assigns the specific classification symbol to the extracted document, based on the keyword correspondence information, extracts a document to which the prescribed classification symbol is not assigned and which includes the recorded related term, calculates the score based on the evaluated value of the related term included in the extracted document and the number of related terms, assigns the predetermined classification symbol to the document having the score exceeding a certain value among the documents including the related term, based on the score and the related term correspondence information, accepts assignment of the classification symbol by the user to the document to which the predetermined classification symbol is not assigned, analyzes the document to which assignment of the classification symbol by the user is accepted, and assigns the classification symbol to the document assigned no classification symbol, based on the analysis result.

A document classification program that obtains digital information recorded in computers or servers, analyzes document information including multiple documents included in the obtained digital information, and assigns the document a classification symbol that represents a degree of relevancy to a litigation so as to facilitate use for the litigation, the program causing a computer to achieve a function that records a specific classification symbol, a keyword described in the document assigned the specific classification symbol, and keyword correspondence information representing correspondence relationship between the specific classification symbol and the keyword, in a keyword database, a function that records a predetermined classification symbol, a related term including a word having a high appearance frequency in the document assigned the predetermined classification symbol, and related term correspondence information representing correspondence relationship between the predetermined classification symbol and the related term, in a related term database, a function that extracts a document including the recorded keyword from the document information, assigns the prescribed classification symbol to the extracted document, based on the keyword correspondence information, a function that extracts a document to which the prescribed classification symbol is not assigned and which includes the recorded related term, calculates the score based on the evaluated value of the related term included in the extracted document and the number of related terms, assigns the predetermined classification symbol to the document having the score exceeding a certain value among the documents including the related term, based on the score and the related term correspondence information, a function that accepts assignment of the classification symbol by the user to the document to which the predetermined classification symbol is not assigned, a function that analyzes the document to which assignment of the classification symbol by the user is accepted, and a function that assigns the classification symbol to the document assigned no classification symbol, based on the analysis result.

### REFERENCE SIGNS LIST

1 Correlation display system (data analysis system)
2 Information processing apparatus
3 Document classification system (data analysis system)
4 Document classification system (data analysis system)
5 Data analysis system
10 Communication data obtaining unit
11 Input unit
12 Analyzer
14 Network analyzer
16 Evaluator
100 Data storage
101 Keyword database
102 Related term database
112 Document extractor
114 Word searcher
116 Score calculator
118 Classification-symbol-accepted document analyzer
120 Language determiner
121 Identifying section
122 Association assigner
124 Tendency information generator
126 Translator
131 Classification symbol accepting and assigning unit
150 Data storage
151 Keyword database
152 Related term database
162 Document extractor
164 Word searcher
166 Score calculator
168 Classification-symbol-accepted document analyzer
170 Language determiner
172 Translator
174 Word selector
176 Document excluder
181 Classification symbol accepting and assigning unit
201 First automatic classifier
251 First automatic classifier
301 Second automatic classifier
351 Second automatic classifier
401 Third automatic classifier
451 Third automatic classifier
501 Quality inspector
551 Learning unit
601 Display unit
651 Display unit
I1 Document display screen

1. A data analysis system that analyzes data recorded in a predetermined computer, comprising:
an identifying section that, when a first word that indicates a predetermined action is included in the data, identifies a second word that indicates an object of the predetermined action; and
an association assigner that associates attribute information that indicates an attribute of data including the first word and the second word with the first word and second word.

2. The system according to claim 1, wherein the attribute information is a name of a person having transmitted the data, a name of a person having received the data, an address that can identify the person, a date and time when the data was transmitted and received, or a date and time when the data was created.

3. The system according to claim 1, further comprising an evaluator that evaluates a relationship between the data and a predetermined case, based on the attribute information and the first word and the second word associated by the association assigner.

4-8. (canceled)

9. The system according to claim 2, further comprising an evaluator that evaluates a relationship between the data and a predetermined case, based on the attribute information and the first word and the second word associated by the association assigner.

10. The system according to claim 3, wherein the predetermined case is information indicating a relationship with a litigation or a fraud investigation.

11. The system according to claim 9, wherein the predetermined case is information indicating a relationship with a litigation or a fraud investigation.

12. The system according to claim 3, further comprising a display unit that displays a relationship between people related to the case, based on a result of evaluation by the evaluator.

13. The system according to claim 9, further comprising a display unit that displays a relationship between people related to the case, based on a result of evaluation by the evaluator.

14. The system according to claim 1, further comprising a communication data obtaining unit that obtains, as the data, communication information that has been transmitted and received between terminals and is associated with each of people.

15. The system according to claim 2, further comprising a communication data obtaining unit that obtains, as the data, communication information that has been transmitted and received between terminals and is associated with each of people.

16. The system according to claim 3, further comprising a communication data obtaining unit that obtains, as the data, communication information that has been transmitted and received between terminals and is associated with each of people.

17. The system according to claim 9, further comprising a communication data obtaining unit that obtains, as the data, communication information that has been transmitted and received between terminals and is associated with each of people.

18. The system according to claim 10, further comprising a communication data obtaining unit that obtains, as the data, communication information that has been transmitted and received between terminals and is associated with each of people.

19. The system according to claim 11, further comprising a communication data obtaining unit that obtains, as the data, communication information that has been transmitted and received between terminals and is associated with each of people.

20. The system according to claim 12, further comprising a communication data obtaining unit that obtains, as the data, communication information that has been transmitted and received between terminals and is associated with each of people.

21. The system according to claim 13, further comprising a communication data obtaining unit that obtains, as the data, communication information that has been transmitted and received between terminals and is associated with each of people.

22. A data analysis method that analyzes data recorded in a predetermined computer, comprising:
an identifying step of, when a first word that indicates a predetermined action is included in the data, identifying a second word that indicates an object of the predetermined action; and
an association assigning step of associating attribute information that indicates an attribute of data including the first word and the second word with the first word and second word.

23. A data analysis program that analyzes data recorded in a predetermined computer, the program causing the computer to achieve:
an identifying function that, when a first word that indicates a predetermined action is included in the data, identifies a second word that indicates an object of the predetermined action; and
an association assigning function that associates attribute information that indicates an attribute of data including the first word and the second word with the first word and second word.
